(19) United States
(12) Patent Application Publication
(10) Pub. No.: US 2026/0166987 A1
(43) Pub. Date: Jun. 18, 2026

(54) COMPONENT FOR VEHICLE INTERIOR

(71) Applicant: Yanfeng International Automotive Technology Co. Ltd., Novi, MI (US)

(72) Inventors: Junwei ZHANG, Shanghai (CN); Qiwei GONG, Shanghai (CN); Jiajun DING, Shanghai (CN)

(21) Appl. No.: 19/417,264

(22) Filed: Dec. 11, 2025

Related U.S. Application Data
(63) Continuation-in-part of application No. PCT/CN2024/098337, filed on Jun. 11, 2024.

(30) Foreign Application Priority Data
Jun. 12, 2023 (CN) 202321486437.1

(51) Int. Cl. B60K 35/00; B60K 35/60; G06F 3/01; G06F 3/0482; G06F 3/0488

(52) U.S. Cl. CPC B60K 35/00; B60K 35/60; G06F 3/016; G06F 3/0482; G06F 3/0488

(57) ABSTRACT

A component for a vehicle interior configured to provide a user interface comprising an operator control is disclosed. The operator control comprises a base comprising a module and a control member configured to provide the user interface providing an input device and/or an output device; the control member of the operator control may comprise the input device and/or the output device. The input device may comprise a sensor-detector; the output device may comprise a visual/light display and/or haptics output. The control member may comprise a multi-function control member/knob configured to provide multiple control actions. Movement of the control member for control action may comprise at least one of lateral movement and/or up-and-down movement and/or rotation movement. The module is configured to facilitate actuation for the control member. The operator control may comprise a multi-function control member to integrate control action. Control action may comprise multiple control modes for vehicle systems.

### CROSS-REFERENCE TO RELATED APPLICATIONS

The present application is a continuation-in-part of PCT/International Patent Application No. PCT/CN2024/098337 titled “MULTIFUNCTIONAL KNOB” filed Jun. 11, 2024, that claims the benefit of Chinese Patent Application No. 202321486437.1 titled “MULTIFUNCTIONAL KNOB” filed Jun. 12, 2023.

The present application claims priority to and incorporates by reference in full: (1) PCT/International Patent Application No. PCT/CN2024/098337 titled “MULTIFUNCTIONAL KNOB” filed Jun. 11, 2024; and (2) Chinese Patent Application No. 202321486437.1 titled “MULTIFUNCTIONAL KNOB” filed Jun. 12, 2023.

### FIELD

The present invention relates to an operator control for a component of a vehicle interior.

The present invention relates to an operator control comprising a multi-function control member for a component of a vehicle interior.

### BACKGROUND

It is known to provide a vehicle interior component comprising an operator control such as a multi-function control member.

It would be advantageous to provide an improved component for a vehicle interior comprising an operator control comprising a control member configured to connect with a system in a vehicle.

It would be advantageous to provide an improved component for a vehicle interior comprising an operator control comprising a multi-function control member integrated with the component and providing a user interface configured to connect with a system in a vehicle.

### SUMMARY

The present invention relates to a component for a vehicle interior configured to provide a user interface; the user interface may comprise an operator control comprising a base comprising a module and a control member connected to the module; the operator control may be configured to provide the user interface at the cover; the user interface may comprise an input device and/or an output device; the control member of the operator control may comprise the input device for the user interface; the input device may comprise at least one of a movement detector and/or a touch sensor; the control member of the operator control may comprise the output device for the user interface; the output device may comprise at least one of a visual display and/or a light display and/or an information display and/or a haptics output; the control member may comprise a multi-function control member configured to provide multiple control actions for the module of the operator control for at least one system of the vehicle; the module may comprise an actuator for the operator control and/or for the output device provided at the operator control; the output device may be configured to provide actuation and/or haptic output and/or vibration; the base may comprise a housing for the module; the component may further comprise a cover for the base; the module may be under the cover; the control member may comprise a knob; the control member may comprise a light display; the control member may comprise a sensor and/or a detector and/or a touch sensor and/or a member configured to operate as a switch; the operator control may comprise a default state where the control member may be recessed into the cover; the control member may be configured for movement relative to the base; the control member may be configured for movement relative to the base for control actions for a system of the vehicle; the operator control may be configured to provide control action at the control member for operation of at least one system of the vehicle; the control member may be configured for rotation movement relative to the base; the control member may be configured for lateral movement relative to the base; the control member may be configured for up-and-down movement relative to the base; movement of the control member relative to the base may comprise all of lateral movement and up-and-down movement and rotation movement; movement of the control member of the operator control may be detected at the module of the operator control; the module of the operator control may be configured to facilitate actuation for the control member.

The present invention relates to a component for a vehicle interior configured to provide a user interface comprising an operator control comprising a base comprising a module and a control member connected to the module; the operator control may be configured to provide the user interface at the cover; the user interface may comprise an input device and/or an output device; the control member of the operator control may comprise the input device for the user interface. The input device may comprise at least one of a movement detector and/or a touch sensor. The control member of the operator control may comprise the output device for the user interface. The output device may comprise at least one of a visual display and/or a light display and/or an information display and/or a haptics output. The control member may comprise a multi-function control member; the control member may comprise a multi-function control member configured to provide multiple control actions for the operator control; the control member may comprise a multi-function control member configured to provide multiple control actions for the module of the operator control; the control member may comprise a multi-function control member configured to provide multiple control actions for the module of the operator control for at least one system of the vehicle. The module may comprise a sensor for the operator control; the module may comprise a sensor for the input device provided at the operator control; the input device may comprise at least one of a touch sensor and/or a micro-switch and/or a photo-detector. The module may comprise an actuator for the operator control; the module may comprise an actuator for the output device provided at the operator control; the actuator may comprise a motor; the module may comprise a transducer for the operator control; the module may comprise a transducer for the output device provided at the operator control; the transducer may comprise a haptics module and/or a vibration element. The output device may comprise at least one of a transducer and/or an actuator; the output device may be configured to provide actuation and/or haptic output and/or vibration. The base may comprise a housing for the module; a cover may be provided for the base. The module may be under the cover. The control member may comprise a knob; the control member may comprise a dial. The control member may comprise a light display; the control member may comprise a display panel; the control member may comprise a light display configured to provide an image; the control member may comprise a display panel configured to provide information; the light display may comprise a light panel; the light display may comprise an LED display. The control member may comprise a sensor; the control member may comprise a detector; the control member may comprise a touch sensor; the control member may comprise a switch; the control member may be configured to operate as a switch. The control member may be connected to the module by a member such as a post. The control member may be movable relative to the base. The operator control may comprise a default state where the control member may be recessed into the cover. The operator control may comprise a use state where the control member may be extended from the cover. The control member may be configured for movement relative to the base; the control member may be configured for movement relative to the base for control actions for a system of the vehicle; the operator control may be configured to provide control actions at the control member for operation of at least one system of the vehicle. The control member may be configured for rotation movement relative to the base. The control member may be configured for lateral movement relative to the base; lateral movement may comprise side-to-side movement; lateral movement may comprise front-to-rear movement; lateral movement may comprise side-to-side movement and front-to-rear movement. The control member may be configured for up-and-down movement relative to the base; up-and-down movement may comprise push-pull movement. Movement of the control member relative to the base may comprise at least one of lateral movement and/or up-and-down movement and/or rotation movement; movement of the control member relative to the base may comprise all of lateral movement and up-and-down movement and rotation movement. Movement of the control member of the operator control may be detected at the module of the operator control; movement of the control member of the operator control may be actuated at the module of the operator control. The module of the operator control may be configured to facilitate actuation for the control member; the module may comprise a magnetic element to facilitate actuation; the module may comprise a spring arrangement to facilitate actuation; the module may comprise a gear element to facilitate actuation; the module may comprise a gear system to facilitate actuation; the module may comprise a track system to facilitate actuation; the module may comprise a drive system to facilitate actuation; the module may comprise a motor to facilitate actuation; the module may comprise a motor-driven system to facilitate actuation. The module may comprise a control system to facilitate actuation. The module may be configured to provide actuation to return the control member to a default position; the default position may comprise a generally central position of lateral movement; the default position may comprise a generally recessed position for up-and-down movement; the default position may comprise a generally central position of rotation movement. The module may be configured to detect movement of the control member; the module may be configured to detect movement of the control member as a control action for the operator control; the module may be configured to detect movement of the control member as a control action for the operator control for at least one system of the vehicle; the module may be configured to detect movement of the control member as a control action for the operator control as an input device for the user interface. The operator control may be configured to provide an integrated control module for systems of the vehicle. The control member may comprise a rotary dial. The control member may comprise a lever arm. The operator control may comprise a multi-function knob comprising the control member to integrate control action. The control action may comprise multiple control modes for at least one system of the vehicle; the control action may comprise multiple control actions; multiple control actions comprise movement of the control member relative to the base; multiple control actions comprise rotation and movement up/down on a Z-axis and movement on an X-axis and movement on a Y-axis; multiple control actions comprise rotation and movement up/down on a Z-axis and movement on an X-axis and movement on a Y-axis and/or vibration/haptics and/or touch/sensing and/or illumination and/or light display; multiple control actions comprise rotation and movement up/down on a Z-axis and movement on an X-axis and movement on a Y-axis and vibration/haptics and touch/sensing and illumination and light display; the light display may comprise an image display providing an icon/information; multiple control actions may be provided at the user interface; multiple control actions comprise connection to at least one system of the vehicle through an interface; multiple control actions comprise connection to a function of at least one system of the vehicle through an interface; multiple control actions comprise connection to operation of at least one system of the vehicle through an interface. The operator control may comprise a multi-function controller configured to provide control actions at the module for a control system for at least one system of the vehicle; control actions comprise rotation, up-down action (Z-axis) motion, left-right/front-back action (X-axis and Y-axis) motion, touch-sensor/haptic action at the user interface configured to provide an input device and/or an output device; the input device may comprise a sensor/detector; the output device may comprise a display/light; the operator control may comprise a multi-function controller with a knob/dial configured to provide control action at the user interface. The module for the operator control may comprise at least one of a sensor/sensor set and/or a switch set and or a magnet system and/or a light/display and/or a haptic/vibration/audio system and/or a gear/track system and/or a motor/actuator; the module for the operator control may comprise a system interface configured to connect to a vehicle system/network; the sensor/sensor set may comprise a touch sensor/detector and/or a photo-electric detector; the switch set may comprise a micro switch arrangement; the magnet system may comprise magnetic elements; the light/display may comprise at least one of an illuminated surface and/or an illuminated dial and/or a display for image/icon/information presentation. The control member may comprise at least two control members.

### FIGURES

FIG. 1A is a schematic perspective view of a vehicle according to an exemplary embodiment.

FIG. 1B is a schematic perspective section view of a vehicle showing a vehicle interior according to an exemplary embodiment.

FIG. 2A is a schematic front perspective view of a vehicle interior with operator controls for a component according to an exemplary embodiment.

FIGS. 2B through 2G are schematic perspective views of a component for a vehicle interior according to an exemplary embodiment.

FIG. 3 is a schematic perspective view of a component for a vehicle interior according to an exemplary embodiment.

FIGS. 3A through 3C are schematic side elevation views of a component for a vehicle interior according to an exemplary embodiment.

FIG. 4 is a schematic perspective view of a component for a vehicle interior according to an exemplary embodiment.

FIGS. 4A through 4C are schematic side elevation views of a component for a vehicle interior according to an exemplary embodiment.

FIG. 5A is a schematic perspective exploded view of a component for a vehicle interior according to an exemplary embodiment.

FIG. 5B is a schematic perspective view of a component for a vehicle interior according to an exemplary embodiment.

FIG. 6 is a schematic perspective exploded view of a component for a vehicle interior according to an exemplary embodiment.

FIG. 6A is a schematic perspective view of a component for a vehicle interior according to an exemplary embodiment.

FIG. 7 is a schematic perspective exploded view of a component for a vehicle interior according to an exemplary embodiment.

FIG. 7A is a schematic perspective view of a component for a vehicle interior according to an exemplary embodiment.

FIG. 8 is a schematic perspective view of a component for a vehicle interior according to an exemplary embodiment.

FIG. 9 is a schematic perspective exploded view of a component for a vehicle interior according to an exemplary embodiment.

FIG. 9A is a schematic perspective view of a component for a vehicle interior according to an exemplary embodiment.

FIG. 10 is a schematic perspective view of a component for a vehicle interior according to an exemplary embodiment.

FIGS. 10A and 10B are schematic perspective exploded views of a component for a vehicle interior according to an exemplary embodiment.

FIG. 10C is a schematic perspective view of a component for a vehicle interior according to an exemplary embodiment.

FIG. 11 is a schematic perspective view of a component for a vehicle interior according to an exemplary embodiment.

FIGS. 11A and 11B are schematic perspective exploded views of a component for a vehicle interior according to an exemplary embodiment.

FIG. 11C is a schematic perspective view of a component for a vehicle interior according to an exemplary embodiment.

FIG. 12 is a schematic perspective view of a component for a vehicle interior according to an exemplary embodiment.

FIGS. 12A and 12B are schematic perspective exploded views of a component for a vehicle interior according to an exemplary embodiment.

FIG. 12C is a schematic perspective view of a component for a vehicle interior according to an exemplary embodiment.

FIG. 13 is a schematic perspective view of a component for a vehicle interior according to an exemplary embodiment.

FIGS. 13A and 13B are schematic perspective exploded views of a component for a vehicle interior according to an exemplary embodiment.

FIG. 13C is a schematic perspective view of a component for a vehicle interior according to an exemplary embodiment.

FIGS. 14 and 15 are schematic perspective views of a component for a vehicle interior according to an exemplary embodiment.

FIGS. 16 and 17 are schematic perspective section views of a component for a vehicle interior according to an exemplary embodiment.

FIG. 18 is a schematic perspective section view of a component for a vehicle interior according to an exemplary embodiment.

FIGS. 19 and 20 are schematic perspective detail section views of a component for a vehicle interior according to an exemplary embodiment.

FIGS. 21 and 22 are schematic perspective section views of a component for a vehicle interior according to an exemplary embodiment.

FIGS. 23 and 24 are schematic perspective detail section views of a component for a vehicle interior according to an exemplary embodiment.

FIGS. 25 and 26 are schematic perspective section views of a component for a vehicle interior according to an exemplary embodiment.

FIG. 27A is a schematic perspective view of a component for a vehicle interior according to an exemplary embodiment.

FIG. 27B is a schematic perspective section view of a component for a vehicle interior according to an exemplary embodiment.

FIG. 28A is a schematic perspective section view of a component for a vehicle interior according to an exemplary embodiment.

FIG. 28B is a schematic perspective detail section view of a component for a vehicle interior according to an exemplary embodiment.

FIG. 29A is a schematic perspective section view of a component for a vehicle interior according to an exemplary embodiment.

FIG. 29B is a schematic perspective detail section view of a component for a vehicle interior according to an exemplary embodiment.

FIGS. 30 and 31 are schematic side elevation section views of a component for a vehicle interior according to an exemplary embodiment.

FIG. 32 is a schematic top plan view of an operator control for a component for a vehicle interior according to an exemplary embodiment.

FIGS. 32A and 32B are schematic top plan views of an operator control for a component for a vehicle interior according to an exemplary embodiment.

FIG. 33 is a schematic perspective view of an operator control for a component for a vehicle interior according to an exemplary embodiment.

FIGS. 33A and 33B are schematic perspective views of an operator control for a component for a vehicle interior according to an exemplary embodiment.

FIG. 34 is a schematic perspective view of an operator control for a component for a vehicle interior according to an exemplary embodiment.

FIGS. 34A and 34B are schematic perspective views of an operator control for a component for a vehicle interior according to an exemplary embodiment.

FIG. 35 is a schematic perspective view of an operator control for a component for a vehicle interior according to an exemplary embodiment.

FIGS. 35A and 35B are schematic perspective views of an operator control for a component for a vehicle interior according to an exemplary embodiment.

FIG. 36 is a schematic perspective view of an operator control for a component for a vehicle interior according to an exemplary embodiment.

FIGS. 36A and 36B are schematic perspective views of an operator control for a component for a vehicle interior according to an exemplary embodiment.

FIG. 37 is a schematic perspective view of an operator control for a component for a vehicle interior according to an exemplary embodiment.

FIGS. 37A and 37B are schematic perspective views of an operator control for a component for a vehicle interior according to an exemplary embodiment.

FIG. 38 is a schematic side elevation view of an operator control for a component for a vehicle interior according to an exemplary embodiment.

FIGS. 38A and 38B are schematic side elevation views of an operator control for a component for a vehicle interior according to an exemplary embodiment.

FIG. 39 is a schematic perspective view of an operator control for a component for a vehicle interior according to an exemplary embodiment.

FIGS. 39A and 39B are schematic perspective views of an operator control for a component for a vehicle interior according to an exemplary embodiment.

FIG. 40 is a schematic perspective view of an operator control for a component for a vehicle interior according to an exemplary embodiment.

FIGS. 40A and 40B are schematic perspective views of an operator control for a component for a vehicle interior according to an exemplary embodiment.

FIG. 41 is a schematic side elevation view of an operator control for a component for a vehicle interior according to an exemplary embodiment.

FIGS. 41A and 41B are schematic side elevation views of an operator control for a component for a vehicle interior according to an exemplary embodiment.

FIGS. 42A through 42C are schematic diagrams of the operator control for a component for a vehicle interior according to an exemplary embodiment.

FIGS. 43A and 43B are system block diagrams of the operator control for a component for a vehicle interior according to an exemplary embodiment.

FIGS. 44A and 44B are system block diagrams of the operator control for a component for a vehicle interior according to an exemplary embodiment.

### DESCRIPTION

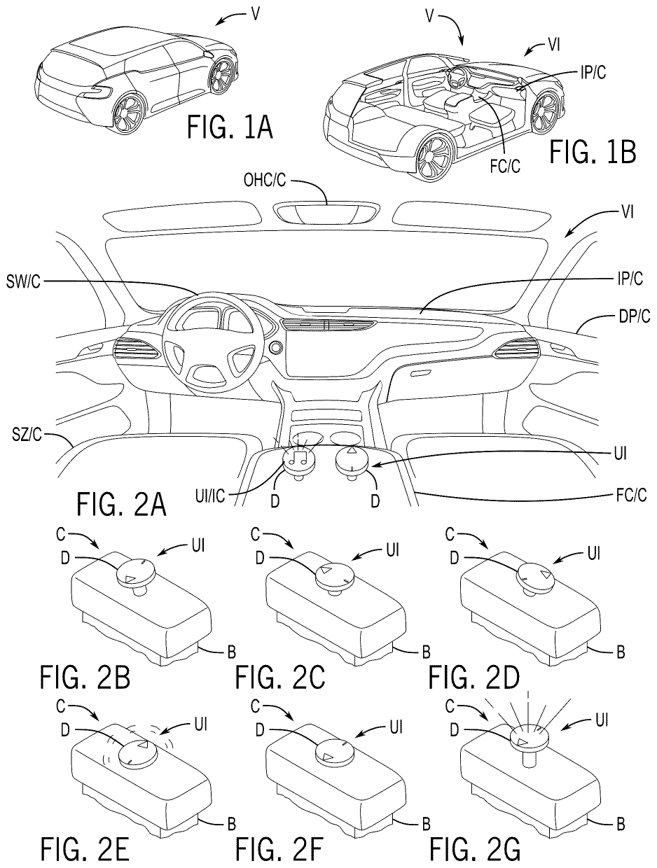

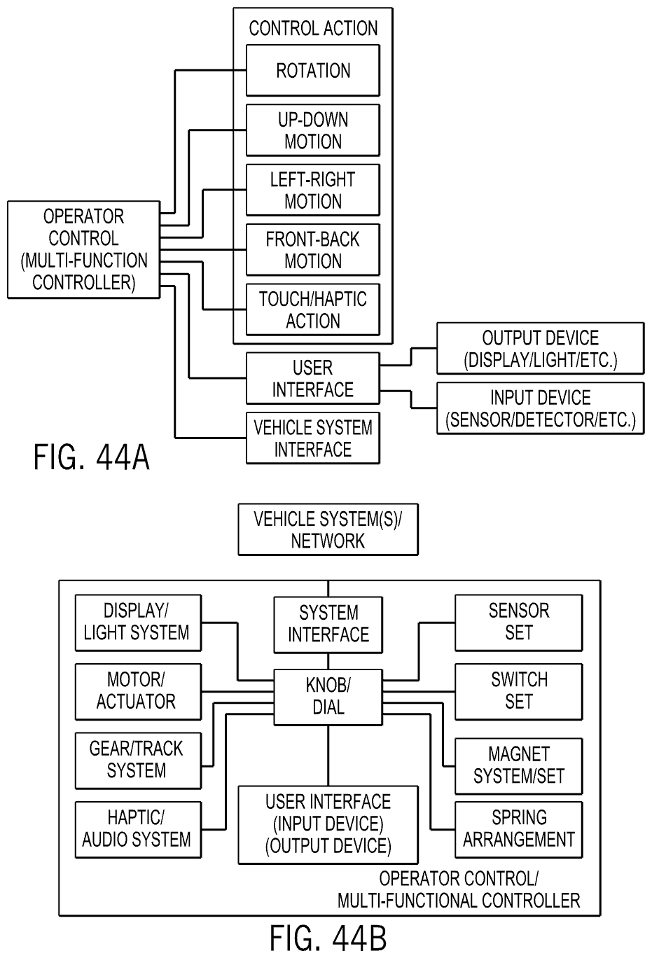

Referring to FIGS. 1A-1C and 2A-2G, a vehicle V is shown comprising an interior VI with components C such as an instrument panel IP, door panel DP, console shown as center/floor console FC, seat SZ, steering wheel SW, overhead system/console OHC, etc.; a component C may comprise an operator control comprising a control member D (shown as a multi-function knob/dial) configured to present a user interface UI for control actions and connection/operation with at least one vehicle system/network. See FIGS. 43A-43B and 44A-44B.

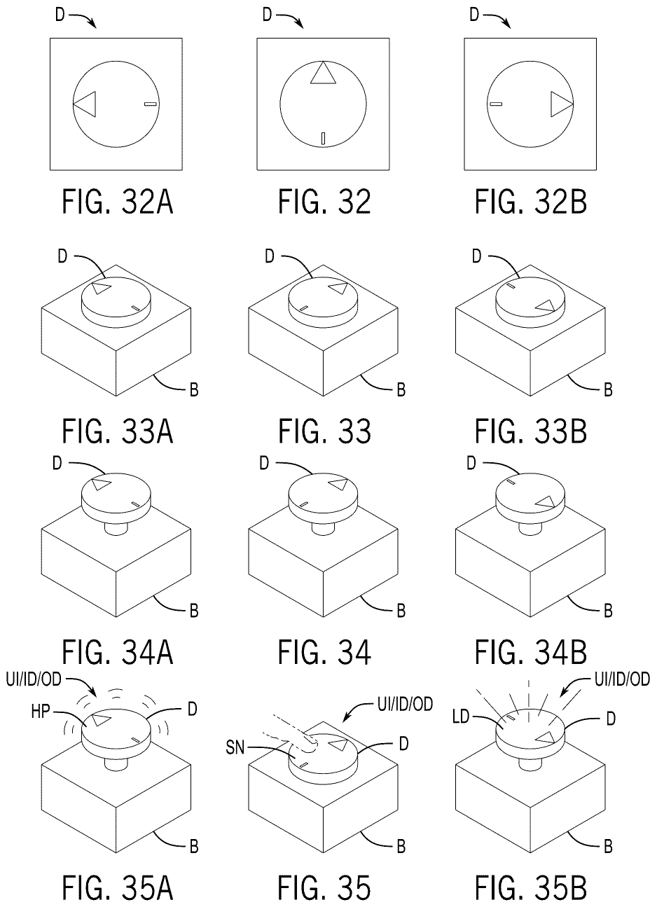

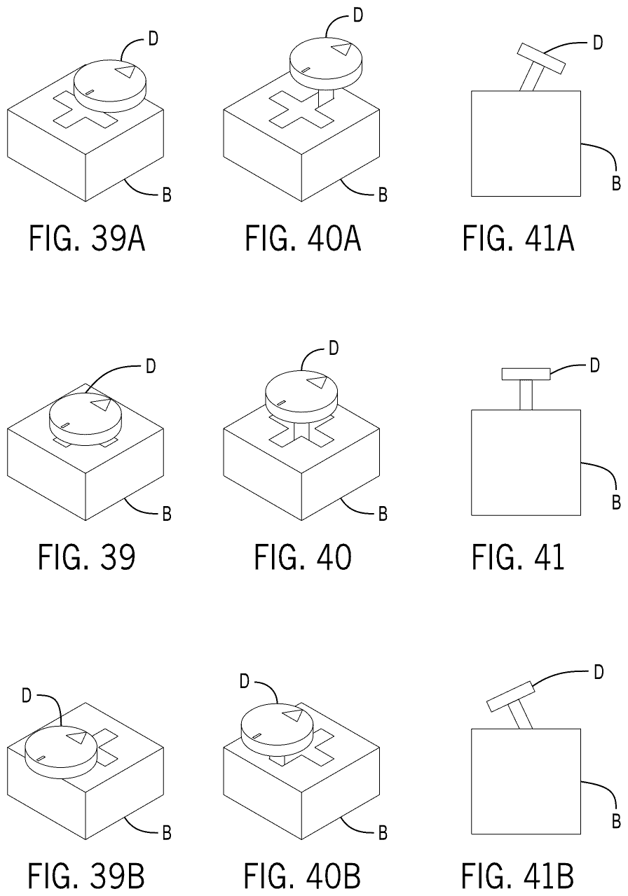

According to an exemplary embodiment as shown schematically in FIGS. 1C, 2A-2G, 3, 3A-3C, 4, 4A-4C and 5A-5B, a component C for a vehicle interior VI may be configured to provide a user interface UI comprising an operator control comprising a base B comprising a module and a control member D connected to the module; the operator control may be configured to provide the user interface UI at the cover T; the user interface UI may comprise an input device ID and/or an output device OD; the control member D of the operator control may comprise the input device ID for the user interface UI. See also FIGS. 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41, 41A-41B, 42A-42C, 43A-43B and 44A-44B. As indicated schematically according to an exemplary embodiment in FIGS. 1B and 2A-2G, the component C comprises an integrated operator control comprising a multi-function control member D providing the user interface UI configured to connect with a system in a vehicle.

As indicated schematically in FIGS. 1B, 2A-2G, 3, 4 and 5A-5B, simplification of control of functions in a vehicle is facilitated by integration of operator controls and control actions for the occupant of the vehicle; integration of an operator control comprising a control member shown as a multi-function knob simplifies control actions and functions and integrates components/parts and assembly; operator controls may be provided with multiple control modes at a control member shown as a multi-function knob. See also FIGS. 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41, 41A-41B, 42A-42C, 43A-43B and 44A-44B.

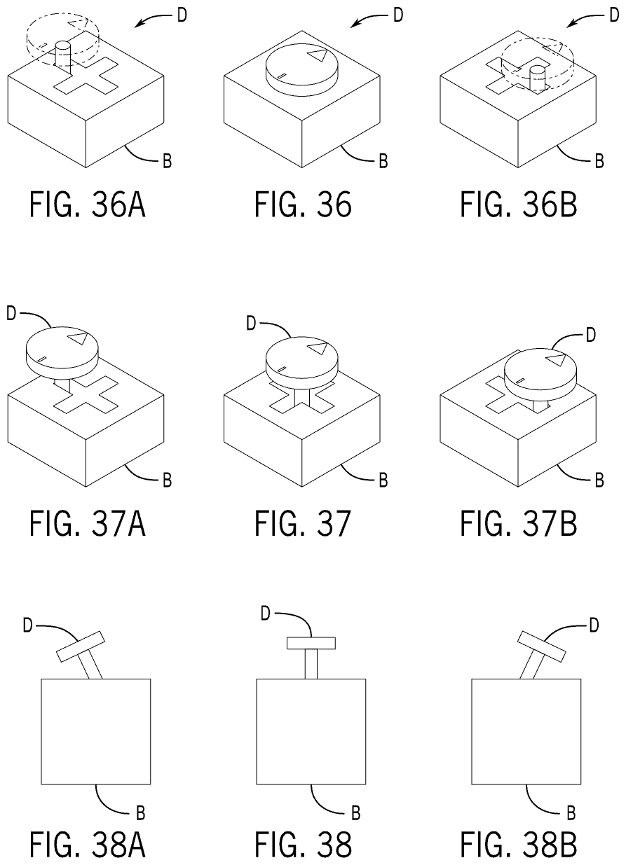

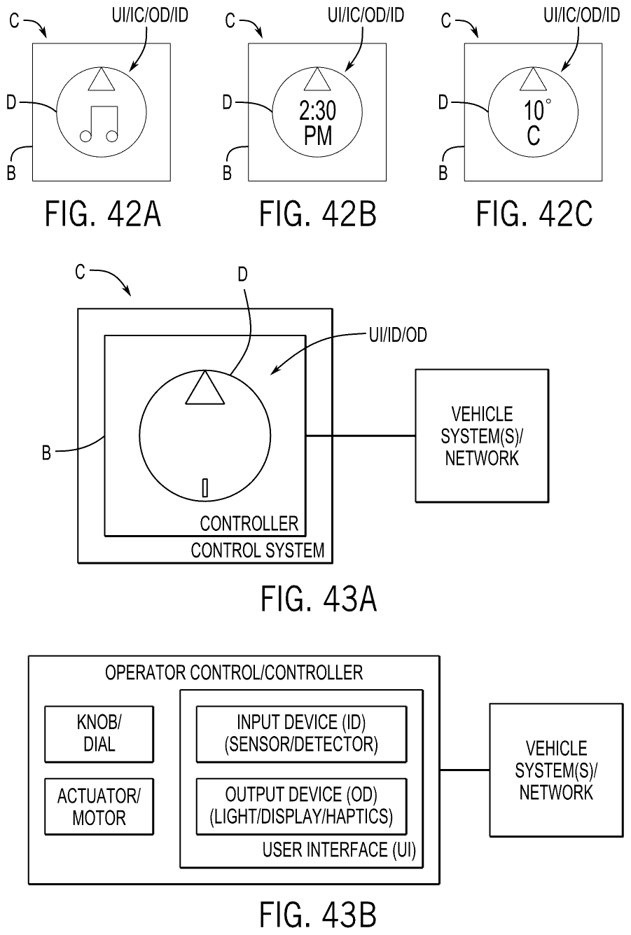

As indicated schematically in the FIGURES, a vehicle interior component C may comprise an operator control comprising a control member shown as multi-function knob D providing multiple control actions as indicated schematically such as rotation (FIGS. 32, 32A-32B, 33, 33A-33B, 34 and 34A-34B) and movement up/down on a Z-axis (FIGS. 33, 33A-33B, 34 and 34A-34B) and vibration/haptics element HP (FIG. 35A) and touch/sensing with sensor SN (FIG. 35) and illumination with light display LD (FIG. 35B) and movement on an X-axis and a Y-axis (as in FIGS. 36, 36A-36B, 37, 37A-37B, 38, 38A-38B, 39, 39A-39B, 40, 40A-40B, 41 and 41A-41B) and an image/light display providing an icon/information IC (FIGS. 42A-42C) and connection to vehicle systems through an interface (FIGS. 43A-43B). See also FIGS. 1B, 2A-2G, 3, 3A-3C, 4, 4A-4C and 44A-44B. As indicated schematically in FIGS. 43A-43B and 44A-44B, the operator control/multi-function controller may be configured to provide multiple control actions including rotation, up-down action (Z-axis) motion, left-right/front-back action (X-axis and Y-axis) motion, touch-sensor/haptic action at a user interface configured to provide an input device (e.g. sensor/detector, etc.) and output device (e.g. display/light, etc.); the operator control may comprise a multi-function controller with a knob/dial configured to provide control action and an user interface with a sensor/sensor set (e.g. touch sensor/detector, photo-electric detector, etc.) and a switch set (e.g. micro switch arrangement) and an magnet system (e.g. magnetic elements) and a light/display (e.g. illuminated dial) for image/icon/information presentation and a haptic/vibration/audio system and a gear/track system and a motor/actuator with a system interface configured to connect to the vehicle system/network.

### Exemplary Embodiments—A

According to an exemplary embodiment as shown schematically in FIGS. 1B, 2A-2G, 3, 4 and 5A-5B, a component C for a vehicle interior may be configured to provide a user interface UI comprising an operator control comprising a base B comprising a module and a control member D connected to the module; the operator control may be configured to provide the user interface UI at the cover T; the user interface UI may comprise an input device ID and/or an output device OD; the control member D of the operator control may comprise the input device ID for the user interface UI; the module may comprise a set of mechanisms and/or sub-assemblies (such as functional mechanisms, sub-systems, etc.) for the operator control. See also FIGS. 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41, 41A-41B, 42A-42C, 43A-43B and 44A-44B.

As indicated schematically in FIGS. 2A-2G, 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41 and 41A-41B, the input device ID may comprise at least one of a movement detector and/or a touch sensor. The control member D of the operator control may comprise the output device OD for the user interface UI. The output device OD may comprise at least one of a visual display and/or a light display and/or an information display and/or a haptics output. See also FIGS. 43A-43B and 44A-44B.

As indicated schematically in FIGS. 2A-2G, 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41 and 41A-41B, 42A-42C, the control member D may comprise a multi-function control member D; the control member D may comprise a multi-function control member D configured to provide multiple control actions for the operator control; the control member D may comprise a multi-function control member D configured to provide multiple control actions for the module of the operator control; the control member D may comprise a multi-function control member D configured to provide multiple control actions for the module of the operator control for at least one system of the vehicle. See also FIGS. 43A-43B and 44A-44B.

As indicated schematically in FIGS. 2A-2G, 3, 3A-3C, 4, 4A-4C, 5A-5B and 35, the module may comprise a sensor for the operator control; the module may comprise a sensor for the input device ID provided at the operator control; the input device ID may comprise at least one of a touch sensor and/or a micro-switch and/or a photo-detector. See also FIGS. 43A-43B and 44A-44B.

As indicated schematically in FIGS. 2A-2G, 3, 3A-3C, 4, 4A-4C, 5A-5B and 35A-35B, the module may comprise an actuator for the operator control; the module may comprise an actuator for the output device OD provided at the operator control; the actuator may comprise a motor. See also FIGS. 43A-43B and 44A-44B. The module may comprise a transducer for the operator control. The module may comprise a transducer for the output device OD provided at the operator control. The transducer may comprise a haptics module and/or a vibration element. The output device OD may comprise at least one of a transducer and/or an actuator. The output device OD may be configured to provide actuation and/or haptic output and/or vibration.

As indicated schematically in FIGS. 2A-2G, 3, 3A-3C, 4, 4A-4C and 5A-5B, the base B may comprise a housing for the module. The component C may comprise a cover T for the base B. The module may be under the cover T; the control member D may comprise a knob; the control member D may comprise a dial; the control member D may comprise a light display and/or display panel; the control member D may comprise a light display configured to provide an image; the control member D may comprise a display panel configured to provide information; the light display may comprise a light panel; the light display may comprise an LED display.

As indicated schematically in FIGS. 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41 and 41A-41B, 42A-42C, the control member D may comprise a sensor and/or a detector; the control member D may comprise a touch sensor; the control member D may comprise a switch; the control member D may be configured to operate as a switch. See also FIGS. 43A-43B and 44A-44B.

As indicated schematically in FIGS. 2A-2G, 3, 3A-3C, 4, 4A-4C and 5A-5B, the control member D may be connected to the module by a post; the control member D may be movable relative to the base B; the operator control may comprise a default state where the control member D may be recessed into the cover T; the operator control may comprise a use state where the control member D may be extended from the cover T; the control member D may be configured for movement relative to the base B; the control member D may be configured for movement relative to the base B for control actions for a system of the vehicle; the operator control may be configured to provide control actions at the control member D for operation of at least one system of the vehicle. See also FIGS. 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41 and 41A-41B, 42A-42C, 43A-43B and 44A-44B.

As indicated schematically in FIGS. 2A-2G, 32, 32A-32B, 33, 33A-33B, 34, 34A-34B and 42A-42C, the control member D may be configured for rotation movement relative to the base B.

As indicated schematically in FIGS. 2A-2G. 36, 36A-36B, 37, 37A-37B, 38, 38A-38B, 39, 39A-39B, 40, 40A-40B, 41 and 41A-41B, the control member D may be configured for lateral movement relative to the base B; lateral movement may comprise side-to-side movement; lateral movement may comprise front-to-rear movement; lateral movement may comprise side-to-side movement and front-to-rear movement. As indicated schematically in FIGS. 2A-2G, 33, 33A-33B, 34, 34A-34B, 35, 35A-35B, the control member D may be configured for up-and-down movement relative to the base B; up-and-down movement may comprise push-pull movement.

As indicated schematically in FIGS. 2A-2G, movement of the control member D relative to the base B may comprise at least one of lateral movement and/or up-and-down movement and/or rotation movement; movement of the control member D relative to the base B may comprise all of lateral movement and up-and-down movement and rotation movement; movement of the control member D of the operator control may be detected at the module of the operator control. See also FIGS. 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41 and 41A-41B, 42A-42C, 43A-43B and 44A-44B.

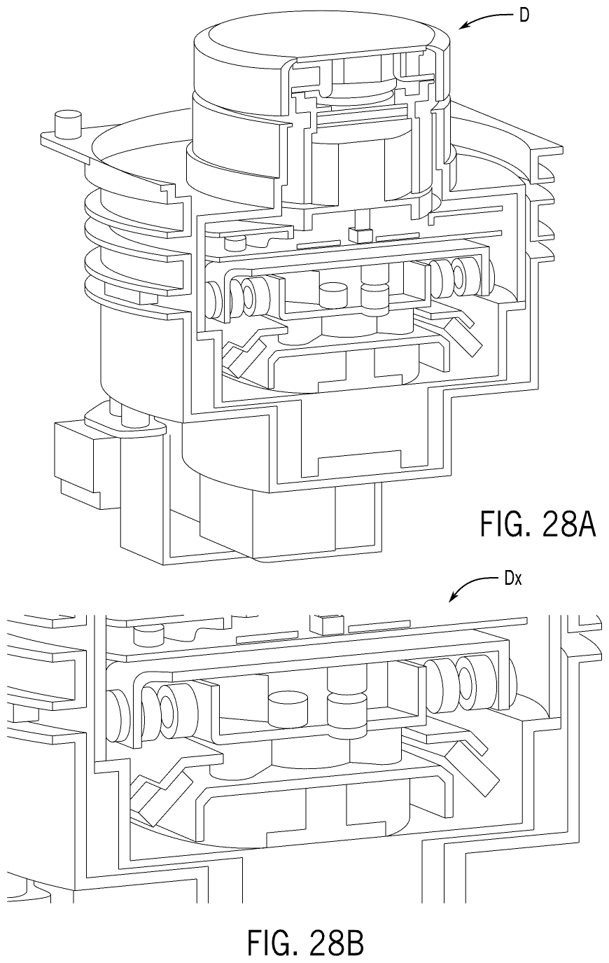

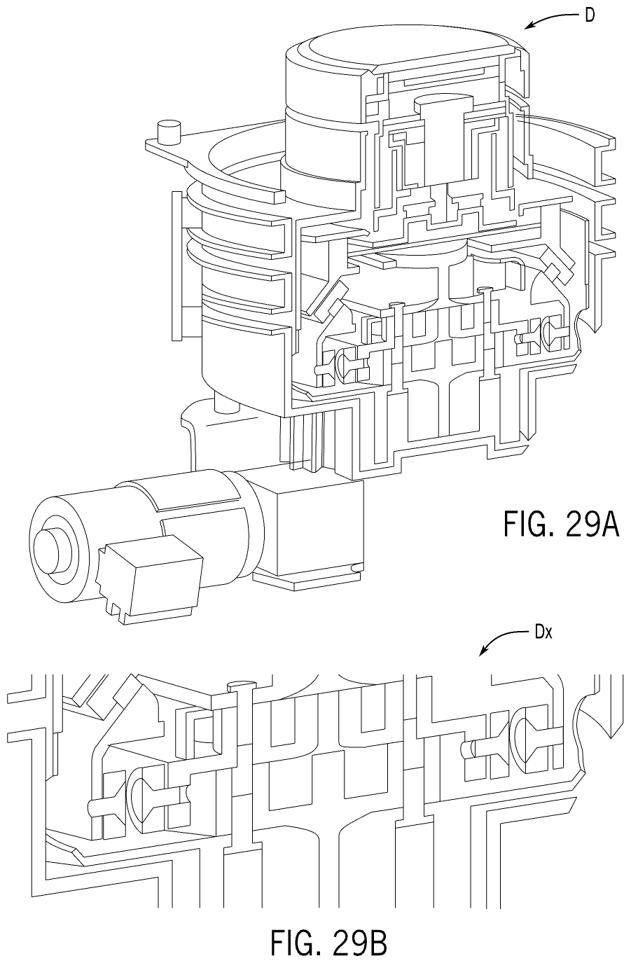

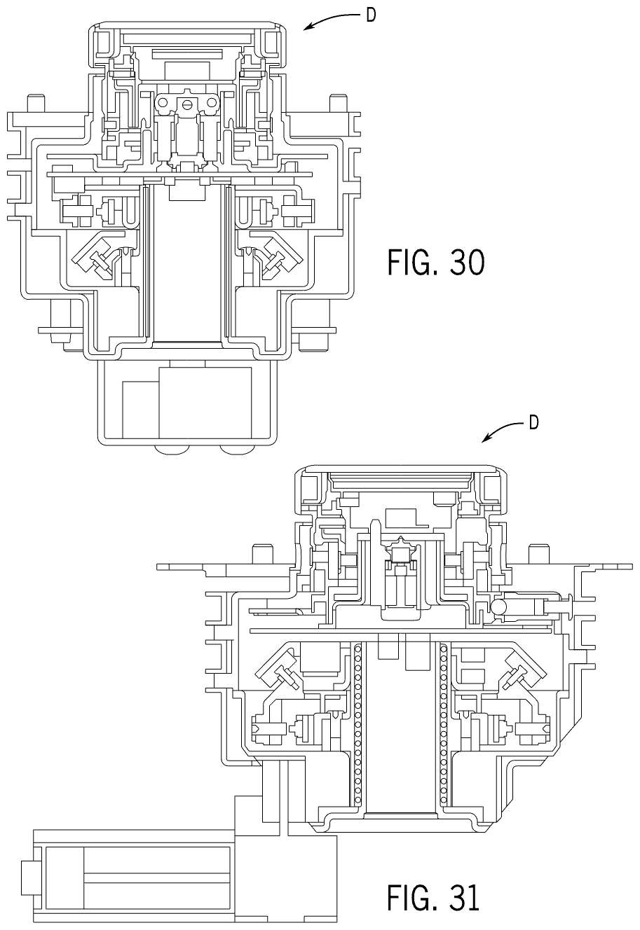

As indicated schematically in FIGS. 2A-2G, 27A-27B, 28A-28B, 29A-29B, 30, 31, 43A-43B and 44A-44B, movement of the control member D of the operator control may be actuated at the module of the operator control; the module of the operator control may be configured to facilitate actuation for the control member D. As indicated schematically, the module may comprise a magnetic element to facilitate actuation; the module may comprise a spring arrangement to facilitate actuation; the module may comprise a gear element to facilitate actuation; the module may comprise a gear system to facilitate actuation; the module may comprise a track system to facilitate actuation; the module may comprise a drive system to facilitate actuation; the module may comprise a motor to facilitate actuation; the module may comprise a motor-driven system to facilitate actuation. See also FIGS. 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41 and 41A-41B, 42A-42C, 43A-43B and 44A-44B.

As indicated schematically in FIGS. 2A-2G, the module may comprise a control system to facilitate actuation; the module may be configured to provide actuation to return the control member D to a default position; the default position may comprise a generally central position of lateral movement; the default position may comprise a generally recessed position for up-and-down movement; the default position may comprise a generally central position of rotation movement; the module may be configured to detect movement of the control member D. See also FIGS. 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41 and 41A-41B, 42A-42C, 43A-43B and 44A-44B.

As indicated schematically in FIGS. 2A-2G, the module may be configured to detect movement of the control member D as a control action for the operator control; the module may be configured to detect movement of the control member D as a control action for the operator control for at least one system of the vehicle; the module may be configured to detect movement of the control member D as a control action for the operator control as an input device ID for the user interface UI. See also FIGS. 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41 and 41A-41B, 42A-42C, 43A-43B and 44A-44B.

As indicated schematically in FIGS. 2A-2G, 43A-43B and 44A-44B, the operator control may be configured to provide an integrated control module for systems of the vehicle at the control member D. As indicated schematically in FIGS. 1B, 2A-2G and 42A-4C, the control member D may comprise a rotary dial. As indicated schematically in FIGS. 1B and 2A-2G, the control member D may comprise a lever arm. As indicated schematically in FIGS. 2A-2G, the operator control may comprise a multi-function knob comprising the control member D to integrate control action; the control action may comprise multiple control modes for at least one system of the vehicle; the control action may comprise multiple control actions; multiple control actions comprise movement of the control member D relative to the base B; multiple control actions comprise rotation and movement up/down on a Z-axis and movement on an X-axis and movement on a Y-axis; multiple control actions comprise rotation and movement up/down on a Z-axis and movement on an X-axis and movement on a Y-axis and/or vibration/haptics and/or touch/sensing and/or illumination and/or light display; multiple control actions comprise rotation and movement up/down on a Z-axis and movement on an X-axis and movement on a Y-axis and vibration/haptics and touch/sensing and illumination and light display; the light display may comprise an image display providing an icon/information; multiple control actions may be provided at the user interface UI; multiple control actions may comprise connection to at least one system of the vehicle through an interface; multiple control actions may comprise connection to a function of at least one system of the vehicle through an interface; multiple control actions may comprise connection to operation of at least one system of the vehicle through an interface. See also FIGS. 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41 and 41A-41B, 42A-42C, 43A-43B and 44A-44B.

As indicated schematically in FIGS. 2A-2G, 43A-43B and 44A-44B, the operator control may comprise a multi-function controller configured to provide control actions at the module for a control system for at least one system of the vehicle; control actions may comprise rotation, up-down action (Z-axis) motion, left-right/front-back action (X-axis and Y-axis) motion, touch-sensor/haptic action at the user interface UI configured to provide an input device ID and/or an output device OD; the input device ID may comprise a sensor/detector; the output device OD may comprise a display/light.

As indicated schematically in FIGS. 2A-2G, 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41 and 41A-41B, 42A-42C, 43A-43B and 44A-44B, the operator control may comprise a multi-function controller with a knob/dial configured to provide control action at the user interface UI; the module for the operator control may comprise at least one of a sensor/sensor set and/or a switch set and or a magnet system and/or a light/display and/or a haptic/vibration/audio system and/or a gear/track system and/or a motor/actuator; the module for the operator control may comprise a system interface configured to connect to a vehicle system/network; the sensor/sensor set may comprise a touch sensor/detector and/or a photo-electric detector; the switch set may comprise a micro switch arrangement; the magnet system may comprise magnetic elements; the light/display may comprise at least one of an illuminated surface and/or an illuminated dial and/or a display for image/icon/information presentation.

As indicated schematically in FIG. 2A, the control member D may comprise at least two control members D.

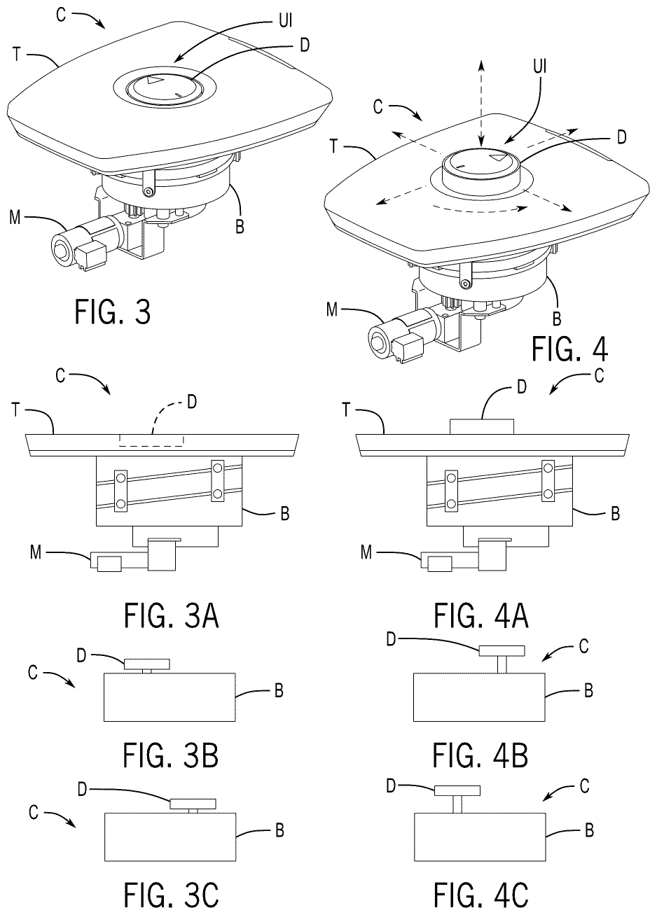

As indicated schematically in FIGS. 2A-2G, 43A-43B and 44A-44B, the component C for a vehicle interior may be configured to provide a user interface UI comprising an operator control comprising a control member D; the operator control may comprise the base B comprising the module M and the control member D configured to provide the user interface UI providing an input device ID and/or an output device OD; the control member of the operator control may comprise the input device and/or the output device; the input device may comprise a sensor-detector; the output device may comprise a visual/light display and/or haptics output; the control member may comprise a multi-function control member/knob configured to provide multiple control actions; movement of the control member for control action may comprise at least one of lateral movement and/or up-and-down movement and/or rotation movement; the module may be configured to facilitate actuation for the control member; the operator control may comprise a multi-function control member to integrate control action; control action may comprise multiple control modes for vehicle systems. FIGS. 3, 4, 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41 and 41A-41B and 42A-42C.

### Exemplary Embodiments—B

As shown schematically in FIGS. 1A-1B and 2A-2G, a component C for a vehicle V comprising an interior VI may comprise an operator control shown as a multi-function knob D; as indicated schematically, the operator control D may be provided on a component C such as a console shown as floor console FC and/or on other components such as an instrument panel IP or door panel DP or a steering wheel SW or a seat SZ or overhead system/console OHC or etc. As shown schematically in FIGS. 2A-2G, the operator control shown as multi-function knob D may be provided on center console assembly FC (between seats in the vehicle); as indicated schematically in FIGS. 2A-2G, 43A-43B and 44A-44B, the operator control D may be configured with a control system configured to control through an interface various functions on various systems of a vehicle and/or to connect to a network, etc.

As indicated schematically, the multi-function knob is assembled on the front side of the center console, regardless of whether the front center console or the rear side center console or the instrument panel may easily touch the front and rear user hands and is assembled on the decorative board and the decorative appearance and function are combined.

As shown schematically in FIGS. 3 to 4, the multifunctional knob Dis assembled on the module/base B; in an initial non-use/off state, the upper surface of the multifunctional knob D is flush with the cover T provided with base B of component C and when the top or other part of the multifunctional knob D is pressed to open the button, the multifunctional knob D rotates along the rising edge and is lifted to the position where the multifunctional knob D may be manipulated by the user from the non-use/off state to present the use/on state. See FIGS. 2A-2G, 3A-3C and 4A-4C. The central small circular screen may have a display function, which may provide additional effects in conjunction with animation. Compared with the prior art having only the lifting function, the synchronous rotation provided by the present disclosure may also combine the rotation animation on the small circular screen to improve the luxury feel or experience of the user as a whole.

As shown schematically in FIG. 4, after the lifting, the multifunctional knob D may be pressed down, pulled upward, left to right and left and right as shown by the arrow. As indicated schematically, forward, backward, left or right toggle, forward and backward rotations correspond to selection interface options, press a corresponding option confirmation downward, pull up a corresponding cancellation or return and the options correspond to various functions, such as an air conditioning function, a light function or an auxiliary function, a system vibration reminder function, etc. As indicated schematically, manipulation at an angle of 45 deg is also feasible, for example, a left-front, left-right, front-right and right-right omni-directional toggle may be achieved by adding components that push the switch. This multi-dimensional manipulation in conjunction with the screen interface, such as the screen interface of the iPad, may find the desired option more quickly or more easily. As indicated schematically, the decorative ring may comprise a metal trim ring to provide a touch sensing function; an occupant may touch the decoration ring; touch-sensing/interaction feedback may be provided in combination with light at the cover of the component (e.g. on the decorative plate).

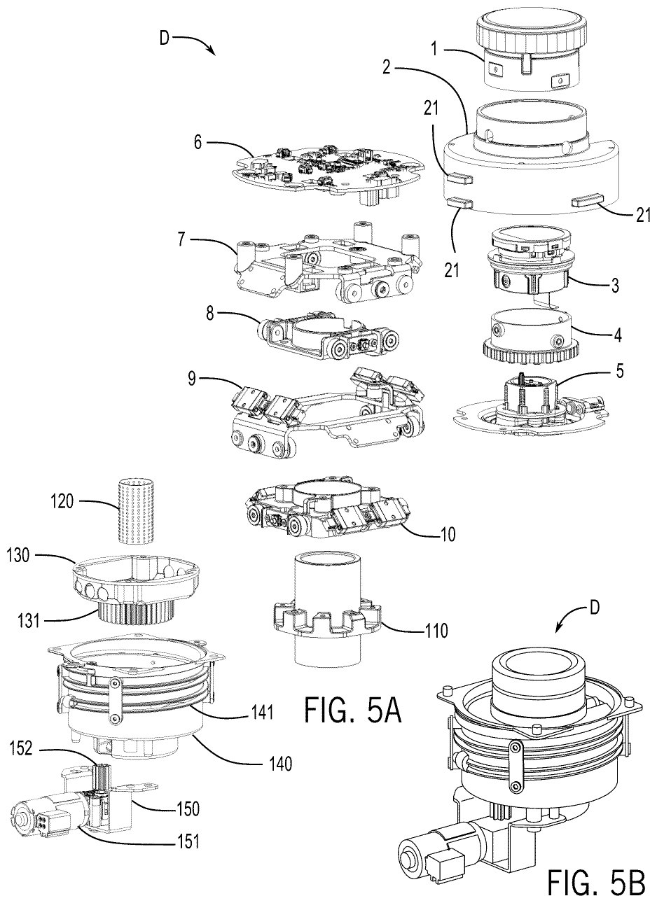

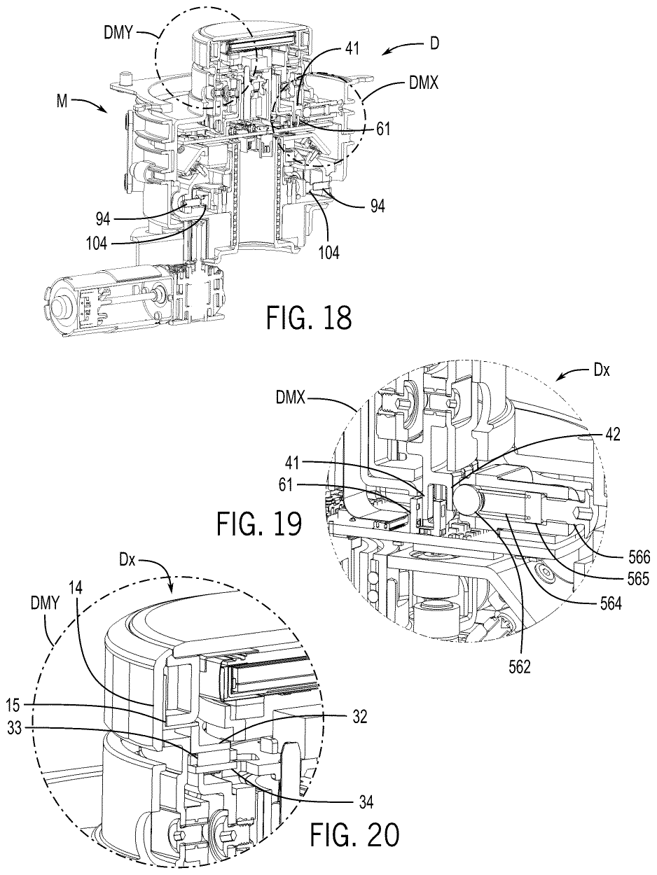

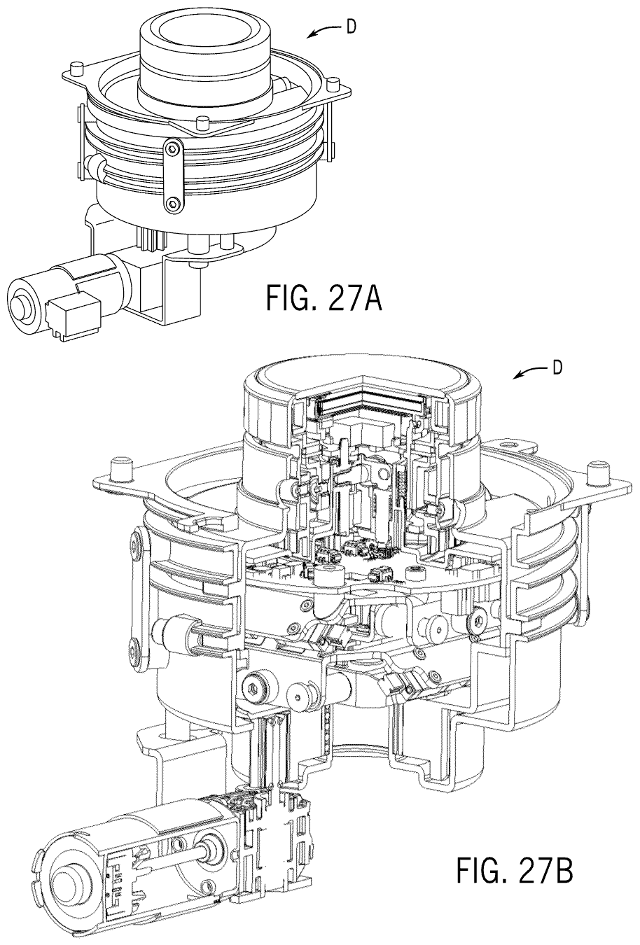

As shown schematically in FIG. 5, the multifunctional knob D may comprise a pressing and lifting rotating mechanism shown schematically in an upper right corner portion, which may comprise a trim ring assembly 1, an inner upper housing 2, a display screen assembly 3, a rotating inner housing 4, a fixed bearing base assembly 5 and a control plate 6, which are used to provide the pressing and pulling and rotating functions as indicated schematically in FIGS. 22 to 24, to provide the above-mentioned screen display and the touch sensing function as indicated schematically in FIGS. 18 to 20. See also FIGS. 27A-27B, 28A-28B, 29A-29B, 30 and 31.

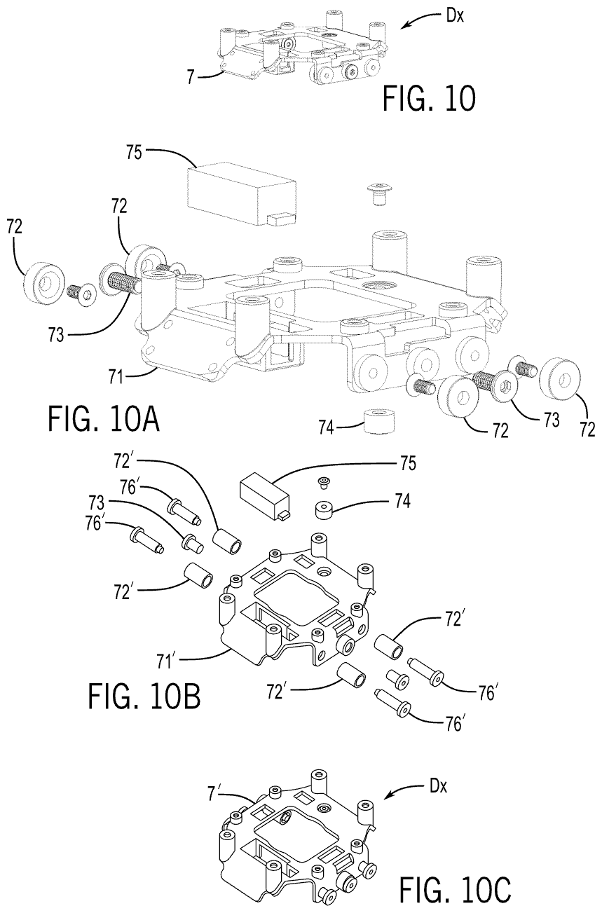

As shown schematically in FIG. 5, the multifunctional knob D may comprise a left and right sliding assembly 7, a left and right sliding rail fixing base assembly 8, a front and rear sliding assembly 9, a front and rear sliding rail fixing base assembly 10 and a central shaft 110 shown schematically in the middle, which are used to provide a left-right front-to-back toggle including the above 45 deg direction toggle as indicated schematically in FIGS. 16 to 17; stability is achieved by the front and rear left and right relative moving tracks and force balance is realized by a magnet arrangement as indicated schematically in FIG. 10A to 13A or a spring solution as indicated schematically in FIG. 10B to 13B to achieve a reset.

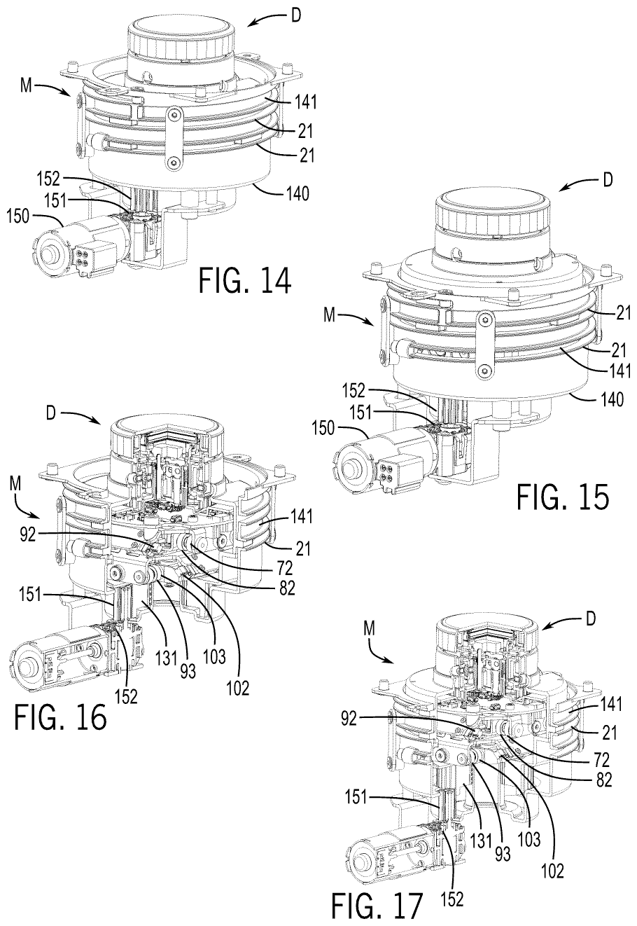

As shown schematically in FIG. 5, the multifunctional knob D may comprise a rotation lifting mechanism shown at a lower left corner, which may comprise a ball bearing 120, an inner bottom shell 130, a housing 140 and a motor assembly 150, which are used to provide a rotation lifting function as indicated schematically in FIGS. 14 to 17 and switch from a just started non-use/off state to a use/on state the gear of the motor drives the entire internal mechanism to rotate to provide a rotation rising motion process through the spiral groove. See also FIGS. 27A-27B, 28A-28B, 29A-29B, 30 and 31.

The specific assembly of the multifunctional knob D may comprise: The outer ring flange of the central shaft 110 is bolted to the front and rear sliding rail fixing base assembly 10 and then assembled with the front and rear sliding assemblies 9 by a sliding rail and a bolt, the left and right sliding rail fixing base assemblies 8 are mounted to the front and rear sliding rail fixing base assembly 10 by bolts, the left and right sliding assemblies 7 are mounted to the front and rear sliding assemblies 9 by sliding rails and bolts and the control plate 6 which is integrated with electronic components connected to the control system by power lines or video data lines, for example, the infrared sensor 61 shown schematically in FIG. 19 and the microswitch 62 and the microswitch 63 as shown schematically in FIGS. 23-24 are assembled on the left and right sliding assemblies 7 by bolts, As indicated schematically, the fixed bearing base assembly 5 is assembled to the left and right sliding assemblies 7 by bolts, the display screen assembly 3 and the fixed bearing base assembly 5 are assembled together by the spring mechanisms 35, 38 and the connecting rod mechanisms 53 and 58 assembling the display screen assembly 3, the rotating inner shell 4 is first placed on the fixed bearing base assembly 5, but no fixing structure, so that the display screen assembly 3 may move up and down in the middle and up and down straight lines in the middle of the fixed bearing base assembly 5 by a certain distance and the piston 54 and 55 mechanism move and reset by the spring mechanisms 35, 38 and the connecting rod 53. The assembled components are assembled into the inner bottom shell 130 by bolts and then the inner upper shell 2 with the sliding block 21 thereon is assembled with the inner bottom shell 130 with the shell gear 131 thereon by bolts; the trim ring assembly 1 is put into the inner bottom shell 2, the inner shell 2 is put into the inner bottom shell 2 and a bolt is mounted on the rotating inner shell 4 through holes on the circumferential surface of the inner upper shell 2. By means of the ball bearing mounted on the circumferential edge of the display screen assembly 3, the ball bearing is matched with the rotating inner housing 4, so that the rotation movement of the trim ring assembly 1 may be realized. As indicated schematically, the ball bearing 120 is placed in the inner ring of the central shaft 110 and between the inner central shaft structure of the housing 140 with the helical groove 141 on it, acting as a linear bearing to rotate the bearing. The motor assembly 150, having the motor gear 151 and the drive gear 152 thereon, is fitted to the housing 140 by a bolt which meshes with the gears at the bottom of the inner bottom shell 130, respectively. The integral knob assembly is fixedly assembled with the cover T provided with base B of component C through the housing 140. See also FIGS. 3, 3A-3C, 4, 4A-4C, 5A-5B, 27A-27B, 28A-28B, 29A-29B, 30 and 31.

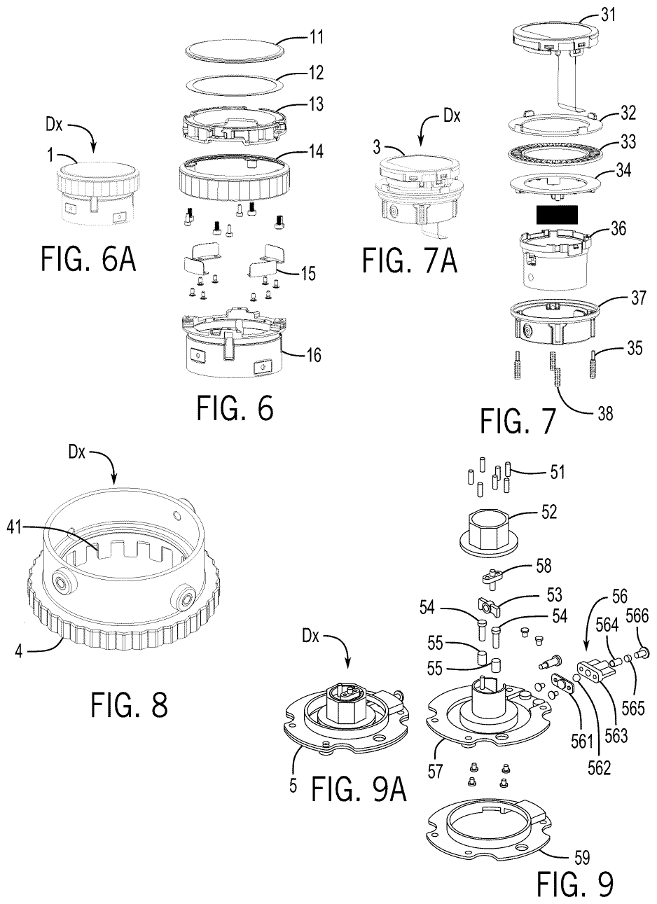

As shown schematically in FIG. 6, the trim ring assembly 1 may comprise a transparent cover 11, a glue 12, a trim carrier 13, a metal trim ring 14, a metal sheet 15 and a rotating support 16 transparent cover 11, which are assembled onto the metal trim 14 and the trim carrier 13 which are assembled together in advance by bolts 12; the metal sheets 15 are assembled on the trim carrier 13 by bolts and the assembled parts are assembled together by bolts and rotating supports 16.

As shown schematically in FIG. 7, the display screen assembly 3 may comprise a display screen 31, a bearing upper cover 32, a needle roller assembly 33, a bearing lower cover 34, a shaft pin bolt 35, a display screen bracket 36, a bearing bracket 37 a ball bearing is assembled on the periphery ring and a compression spring 38 display screen 31 are assembled onto the display screen bracket 36 by a hook structure and the thrust bearing assembly provided by the bearing upper cover 32, the ball assembly 33 and the bearing lower cover 34 is assembled onto the display screen bracket 36 by a shaft hole; the bearing lower cover 34 is mounted on the bearing bracket 37, the two groups of compression springs 38 are sleeved on the bearing bracket 37, the two groups of compression springs 38 are assembled onto the bearing bracket 37 by the shaft pin bolt 35 and a group of pressing reset mechanisms and a lifting reset mechanism are formed; the bearing bracket 37 and the ball bearings assembled thereon form a rotary bearing and the rotation stability and smooth performance of the rotary related parts of the rotary knob are provided; and then, a bearing bracket 37 of the ball bearing is assembled and the bolt and the display screen bracket 36 are assembled together. See also FIGS. 3, 3A-3C, 4, 4A-4C, 5A-5B, 27A-27B, 28A-28B, 29A-29B, 30 and 31.

As shown schematically in FIG. 8, the bottom of the inner ring of the rotating inner shell 4 is provided with a plurality of ribs 41 uniformly spaced apart from each other, providing an infrared sensor to capture a rotation angle signal and the bottom outer ring may have a concave-convex mechanism 42 arranged in a uniform and complete column

As shown schematically in FIG. 9, the fixed bearing base assembly 5 may comprise a ball bearing 51, a bearing bracket 52, a connecting rod 53, a spring piston 54, a spring piston 55, a clutch mechanism 56, a fixed bearing base 57, a connecting rod shaft 58 and a knob outer positioning ring 59 ball bearing 51 assembled into the bearing bracket 52 to form a linear bearing providing an up and down movement function, providing a knob pressing, pulling operation related parts with stable motion and smooth performance. The bearing bracket 52 is mounted on the fixed bearing base 57 by bolts, the spring piston 54 and the spring piston 55 shaft hole are fitted in the fixed bearing base 57, the connecting rod 53 is fitted inside the fixed bearing base 57 through the shaft hole and is pressed against the top surface of the spring piston 54 and the spring piston 55 and the spring piston 54 and the spring piston 55 are tightly attached to the connecting rod 53 through the spring piston 54 and the spring piston 55. The clutch mechanism 56 is assembled on one side of the fixed bearing base 57 by bolts and may comprise a cover 561, a ball 562, a housing 563, a coil spring 564, a push block 565 and a stop bolt 566 spiral spring 564 to push the ball 562 to press the concave-convex structure 42 on the inner housing 4 see FIG. 8 to generate a damping force and a gear positioning sense when the knob is rotated. If the spiral spring 564 and the push block 565 are replaced by two identical magnets, the functions of the rotation damping force realized by the spring and the push block may also be realized. As indicated schematically, if the spiral spring 564 and the push block 565 are replaced by the electromagnet assembly, the damping force may be regulated at any time. See also FIGS. 3, 3A-3C, 4, 4A-4C, 5A-5B, 27A-27B, 28A-28B, 29A-29B, 30 and 31.

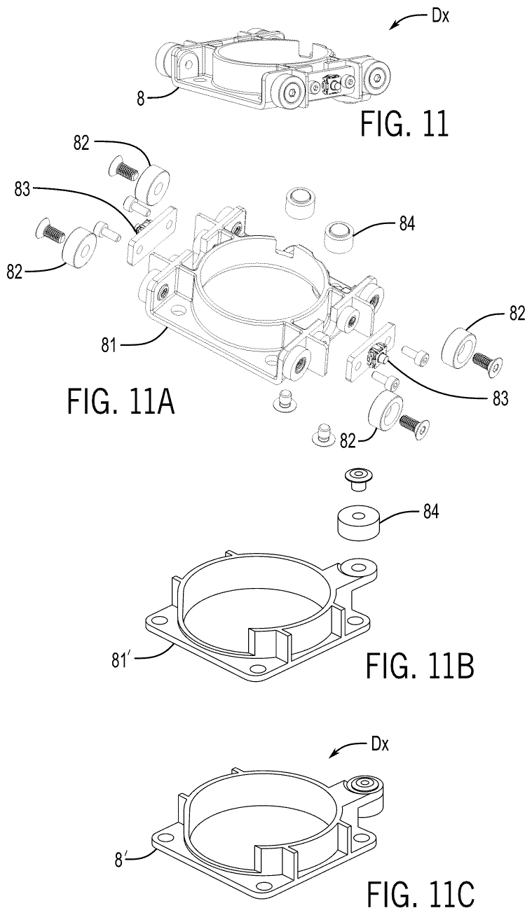

As shown schematically in FIG. 10A, the left and right sliding assemblies 7 of the magnet solution according to one embodiment include left and right sliding rail brackets 71, magnets 72, bolts 73, left and right centering locking magnets 74 and vibrator 75 magnets 72 assembled to the inner side of the left and right sliding rail brackets 71 by bolts and bolts 73 are also assembled on the left and right sides to trigger the microswitch 83 see FIG. 11A to implement the left and right direction toggle knobs to generate signals. The left and right centering locking magnets 74 are assembled on the left and right sliding rail brackets 71 by bolts. The vibrator 75 is assembled onto the left and right sliding rail brackets 71 by glue and since the vibrator is assembled on the left and right sliding assemblies, the vibration direction of the vibrator is also left and right. The vibrator 75 assembled in the left and right sliding assemblies 7 generates vibrations in the left and right directions and provides an assembly for giving a vibration reminding function when operating the knob. In the way, when the operation is limited/wrong, the system provides vibration feedback or a vibration reminding function. As shown schematically in FIG. 10B, the coil spring 72′ of the left and right sliding assembly 7′ of the spring arrangement according to another embodiment is fitted to the left and right slide rail brackets 71′ by bolts 76′. See also FIGS. 3, 3A-3C, 4, 4A-4C, 5A-5B, 27A-27B, 28A-28B, 29A-29B, 30 and 31.

As shown schematically in FIG. 11A, the left and right sliding rail fixing base assemblies 8 of the magnet solution according to one embodiment include left and right sliding rail fixing brackets 81, magnets 82, micro switches 83 and front and rear centering locking magnets 84 magnets 82 mounted on the outer side of the left and right sliding rail fixing brackets 81 by bolts, the micro switch 83 is also assembled outside the left and right sliding rail fixing brackets 81 by bolts and the front and rear centering locking magnets 84 are assembled on the left and right sliding rail fixing brackets 81 by bolts. As shown schematically in FIG. 11B, the spring solution is shown schematically in FIG. 11B and the front and rear centering locking magnets 84 of the left and right sliding rail fixing base assembly 8′ of the spring solution are assembled to the left and right sliding rail fixing brackets 81′. See also FIGS. 3, 3A-3C, 4, 4A-4C, 5A-5B, 27A-27B, 28A-28B, 29A-29B, 30 and 31.

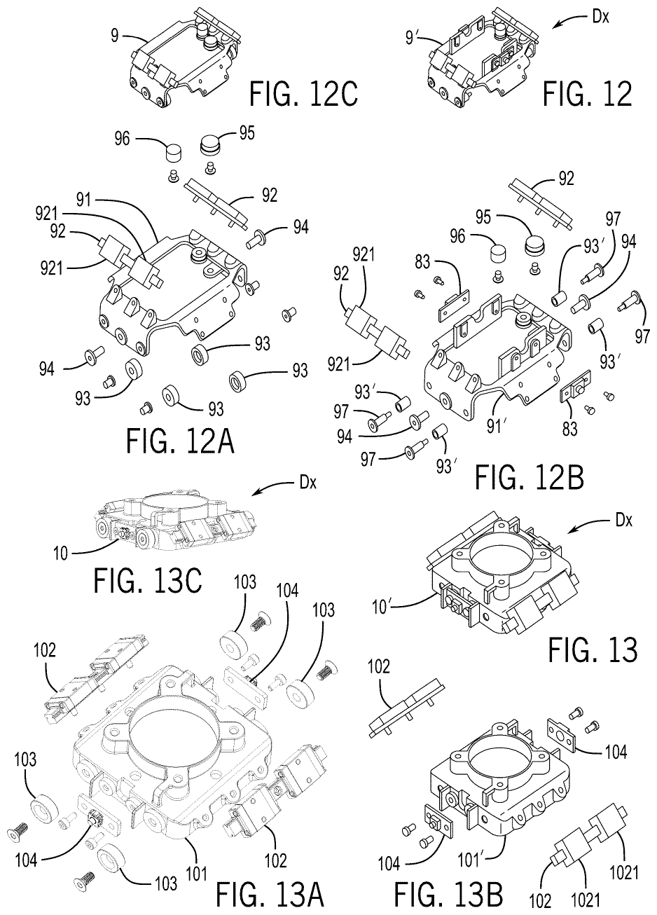

As shown schematically in FIG. 12A, the front and rear sliding assemblies 9 of the magnet arrangement according to one embodiment include the front rear sliding bracket 91, the left and right rails 92, the magnets 93, the bolts 94, the front and rear centering locking magnets 95 and the front and rear centering locking magnets 95 of the front and rear sliding assemblies 9 of the left and right centering locking magnets 9 and the front and rear centering locking magnets 84 of the left and right sliding rail fixing base assembly 8 are arranged opposite to each other in different polarities and the function of the phase suction pair is used to provide the multi-function knob to maintain the centered position locking in the front-rear direction. The left and right centering locking magnets 96 of the front and rear sliding assemblies 9 are arranged opposite to each other with respect to the left and right centering locking magnets 74 of the left and right sliding assemblies 7 to provide a multi-function knob to maintain the centered position locking in the left and right directions. The left and right rails 92 in the left and right direction are controlled to have sliding blocks 921 and are assembled on both sides of the front and rear sliding brackets 91 by bolts, the magnets 93 are assembled on the front and rear sides of the front and rear sliding brackets 91 by bolts, the bolts 94 are assembled on the front and rear sides of the front and rear sliding brackets 91 and the microswitch 104 is triggered when the knob is moved in the front-rear direction see FIG. 13A. As shown schematically in FIG. 12B, the micro switch 83 of the front and rear sliding assemblies 9′ of the spring solution may be assembled to the front and rear sliding brackets 91′ and the front and rear sliding rail fixing base assemblies 10′ and the coil springs 93′ are assembled onto the front and rear sliding brackets 91′ by bolts 97.

As shown schematically in FIG. 13A, the front and rear slide rail fixing base assembly 10 of the magnet arrangement according to one embodiment may comprise a front rear slide rail fixing bracket 101, a front and rear rail 102, a magnet 103 and a micro switch 104 for controlling the front and rear rails 102 sliding in the front and rear directions to have sliding blocks 1021 and are assembled on both sides of the front and rear slide rail fixing brackets 101 by bolts, the magnets 103 are assembled on the front and rear inner sides of the front and rear slide rail fixing brackets 101 by bolts and the micro switch 104 is assembled on the front and rear sides of the front and rear slide rail fixing brackets 101. As shown schematically in FIG. 13B, the front and rear rails 102 of the front and rear slide rail fixing base assembly 10′ of the spring solution are assembled on both sides of the front and rear slide rail fixing brackets 101′ by bolts. See also FIGS. 3, 3A-3C, 4, 4A-4C, 5A-5B, 27A-27B, 28A-28B, 29A-29B, 30 and 31.

As shown schematically in FIGS. 14 to 15, through the cooperation of the spiral groove 141 on the housing 140 and the sliding block 21 on the inner upper housing 2, the sliding block may be sliding friction of the sliding block or rolling friction designed as a ball contact track and may be specifically selected according to material performance requirements. The motor gear 151 and the transmission gear 152 on the motor assembly 150 are engaged with the shell gears 131 of the inner bottom shell 130 and the gear transmission mode may also be determined according to factors such as gear ratio, speed and space. The motor may drive the inner bottom shell 130 and the part of the inner upper shell 2 contained in the inner upper shell 2 to rise.

As indicated schematically in FIGS. 14, 15, 16 and 17, the multi-function knob housing may comprise an inner housing quarter region and the inner part with the inner housing of the multi-function knob housing; the motor gear 151 and the transmission gear 152 of the motor assembly 150 are engaged with the shell gears 131 at the bottom of the inner bottom shell 130, the motor gear 151 rotates to drive the shell gear 131 to rotate and under the combined action of the spiral groove 141 and the sliding block 21, the entire inner bottom shell 130 and the knob assembly comprising the trim ring assembly 1, the display screen assembly 3, the rotating inner shell 4, the fixed bearing base assembly 5, the control board 6, the left and right sliding assemblies 7, the left and right sliding rail fixed base assemblies 8, the front and rear sliding assemblies 9, the front and rear sliding rail fixing base assembly 10 and the central shaft 110 of the inner bottom shell 130 and the inner upper shell 2 all rise or fall. As indicated schematically, FIGS. 16 to 17 May also see the front and rear rails 102 controlling the front and rear directions to move horizontally, the left and right rails 92 to control the left and right directions to move horizontally and the same polarity magnets 93 and 103 that provide the forward and backward directions to toggle the damping force and the return force and provide the same polarity magnets 72 and 82 that toggle the damping force and the return force in the left-right direction. As indicated schematically, the coil springs 72′, 93′ are used to provide the toggle damping force and the return force in the front-rear and left-right directions. See also FIGS. 3, 3A-3C, 4, 4A-4C, 5A-5B, 27A-27B, 28A-28B, 29A-29B, 30 and 31.

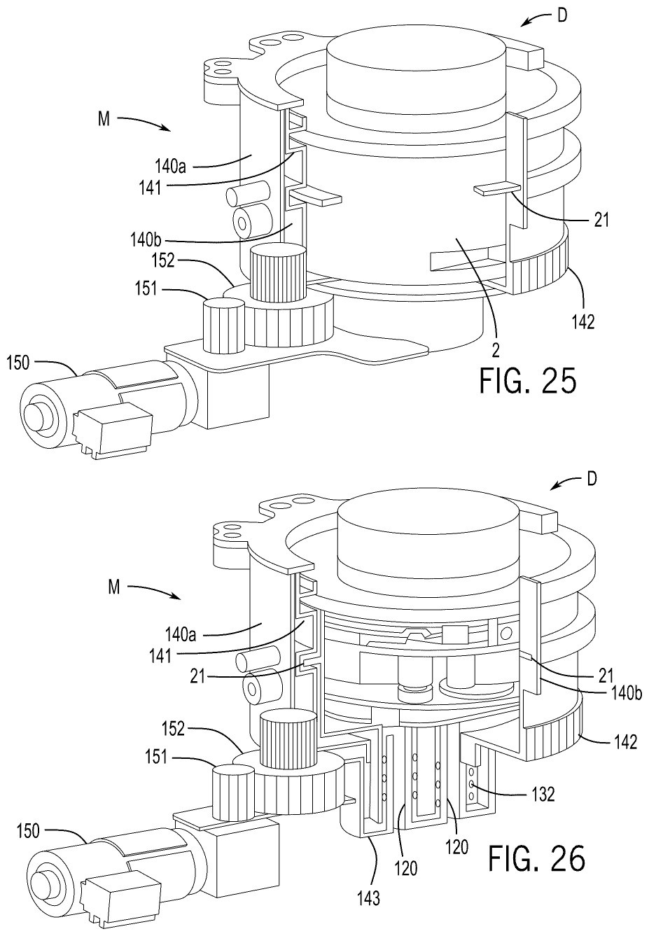

As indicated schematically in FIGS. 25 and 26, a variation of the rotary lifting mechanism of the multifunctional knob D may comprise the rotary motion of the knob assembly in the whole inner bottom shell 130; rotation of the inner upper shell 2 does not occur during the ascending or descending process. As indicated schematically, the implementation variant is to hide only the rotational motion such that rotational movement that occurs inside the housing 140 is not visible during the rising or descending process of the knob assembly.

As indicated schematically in FIGS. 25 and 26, the housing 140 is not a single piece in the embodiment but may be provided as a fixed housing 140a and a rotating housing 140b. The fixed housing 140a may be fixedly assembled with the cover T provided with base B of component C of the vehicle V, the rotating housing 140b may be arranged in the fixed housing 140a and may only rotate relative to the fixed housing 140a under the limit of the fixed housing 140a without ascending or descending. The inner side of the rotating housing 140b may be provided with a helical groove 141 cooperating with the slider 21 on the inner upper housing 2 and the bottom of the rotating housing 140b may be provided with a shell gear 142 meshing with the motor gear 151 and the drive gear 152 of the motor assembly 150.

As indicated schematically, the rotary lifting mechanism may comprise two ball bearings 120; each ball bearing 120 may be provided between the bottom protrusion 143 of the fixed housing 140a and one of the two bottom eccentric lugs 132 of the inner bottom shell 130; the inner bottom shell 130 may be configured to rise or fall relative to the fixed housing 140a but limit the relative rotation of the inner bottom shell 130 with the fixed housing 140a (i.e. achieving that the knob assembly within the inner bottom shell 130 and the inner upper shell 2 may only rise or fall and cannot rotate).

As indicated schematically, when the motor gear 151 rotates to drive the shell gear 142 on the rotating shell 140b to rotate, under the combined action of the spiral groove 141 and the sliding block 21, the entire inner bottom shell 130 and the knob assembly comprising the trim ring assembly 1, the display screen assembly 3, the rotating inner shell 4, the fixed bearing base assembly 5, the control board 6, the left and right sliding assemblies 7, the left and right sliding rail fixed base assemblies 8, the front and rear sliding assemblies 9, the front and rear sliding rail fixing base assembly 10 and the central shaft 110 in the inner bottom shell 130 and the inner upper shell 2 will rise or fall, but will not rotate due to the limitation existing between the inner bottom shell 130 and the fixed shell 140a.

As indicated schematically in FIG. 18, the dial/knob D provided as operator control may be configured to provide front/back movement/action and side/side movement/action (e.g. control action along X axis and Y axis); FIG. 19 is a partial enlarged view of the area/region DMX; FIG. 20 is a partial enlarged view of the area/region DMY. The bolt 94 assembled on the front and rear sliding assembly 9 triggers the microswitch 104 on the front side or the rear side when the bolt 94 on the front and rear sliding assembly 9 may be toggled in the front and rear direction and sends a signal; when the trim ring assembly 1 rotates, the rib 41 at the bottom of the inner ring of the rotating inner housing 4 will pass through the infrared sensor 61 on the control plate 6 and by the vacancy between adjacent ribs 41, the infrared sensor 61 may be continuously allowed to generate or eliminate the signal, so that the rotation angle of the knob may be directly read by the signal; under the action of the spring 564, the ball 562 always compresses the concave-convex structure 42 arranged in the whole column and under the action of the concave-convex structure 42, the ball 562 also reciprocates in the inner cavity of the housing 563 and the ball 562 applies a force generated by the force to the concave-convex structure 42 at the bottom of the outer ring of the inner shell 4 or the damping force of the rotary knob. See also FIGS. 3, 3A-3C, 4, 4A-4C, 5A-5B, 27A-27B, 28A-28B, 29A-29B, 30 and 31.

As indicated schematically in FIG. 20, the user may generate a touch signal by touching the metal trim ring 14. Since the metal trim 14 is in contact with the metal sheet 15 and the metal sheet 15 and the bearing upper cover 32 are in contact (e.g. acting as sensor-detector), the touch signal may be transmitted to the control board 6 through the metal sheet 15, the bearing upper cover 32 of the thrust bearing assembly, the ball assembly 33, the bearing lower cover 34 and the wire harness fitted on the bearing lower cover 34. Metal trim 14 is rotating; the wire harness is directly on the metal trim 14 to pass the signal to the control plate 6; rotation of the wire harness will result in damage; by transmitting the touch signal to the thrust bearing assembly, the bearing lower cover 34 does not rotate, connecting the wire harness to the bearing lower cover 34 avoiding connecting the wire harness to the rotating component; the thrust bearing assembly may be used to couple the rotational movement of the metal trim ring 14 to provide a static bearing lower cover 34 to transmit a signal avoiding the contradiction between the rotational motion and the wiring.

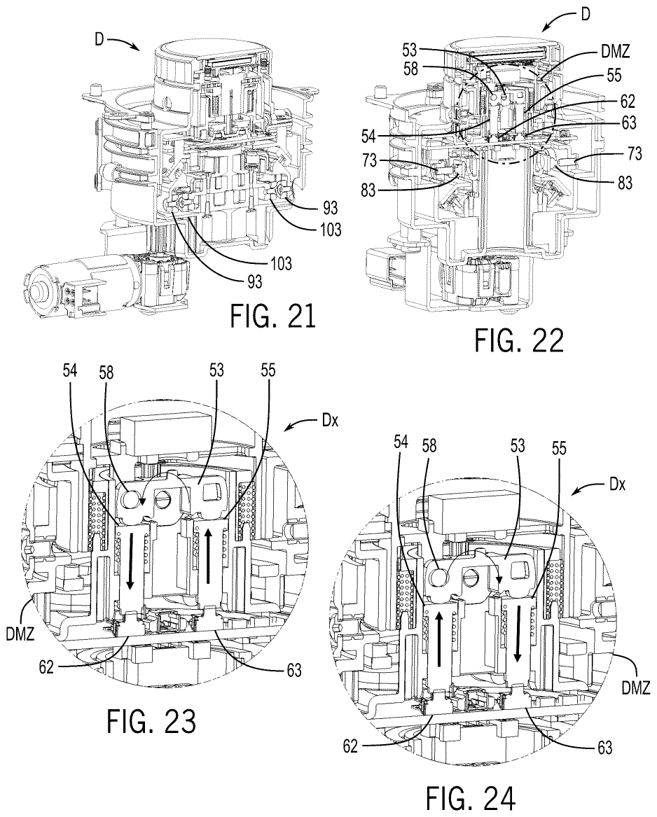

As shown schematically in FIG. 21, the magnets 93 and 103 face-to-face in the same polarity are arranged on the front and rear sides, the knob may be toggled in the current rear direction and under the limit of the front and rear rails 102, the knob may be stably translated by a certain distance and the magnets 93 and 103 on the front and rear sides both generate repulsive forces the damping force against the user to toggle the knob may be achieved and when the user releases the knob, the knob returns to the centered position; the front and rear sides are provided with a pair of magnets that repel the same pole; during the forward and backward movement, as the magnets approach each other, the repulsive force increases and the operating force gradually increases and then returns to the intermediate position after being released.

As indicated schematically in FIG. 22, the dial/knob D provided as operator control is configured to provide press/pull movement/action (e.g. up/down control action in Z axis); FIGS. 23 and 24 are partial enlarged views of the area/region DMZ. The bolts 73 assembled on the left and right sliding assemblies 7 trigger the microswitch 83 on the left side or the right side as the left and right directions of the knob and send signals. The connecting rod 53 assembled in the fixed bearing base assembly 5 may be fitted on the knob fixing bearing base 57 by the shaft hole in the middle of the part itself, may rotate around the middle shaft, the hole in one end passes through the connecting rod shaft 58, the connecting rod shaft 58 is a structure mounted on the display screen bracket 36 in the display screen assembly 3 by bolts and when the top of the knob is pressed, the display screen assembly 3 is driven to descend, the display screen assembly 3 reduces the side of the connecting rod 53 by the connecting rod shaft 58 and the other side is lifted, as shown schematically in FIG. 23, one side of the descending side presses the spring piston 54 to trigger the microswitch 62 and when the knob is lifted, as shown schematically in FIG. 24, the other side of the lever 53 drops and the spring piston 55 triggers the microswitch 63 to implement pressing and pulling the knob trigger signal. See also FIGS. 3, 3A-3C, 4, 4A-4C, 5A-5B, 27A-27B, 28A-28B, 29A-29B, 30 and 31.

### Exemplary Embodiments—X

A vehicle may be equipped with an operator control such as a knob or physical button for controlling the function of a vehicle system; operator control may be provided for a driving function, shifting function, air conditioning function, etc.; such knobs may be rotationally manipulated and/or pressed and/or moved left and right/front and back and/or etc., and operator control may also have a screen display. As indicated schematically, performance of such knobs may relate to functional dispersion, structural redundancy, user experience, convenience, efficacy, etc., and the like. As indicated schematically, simplification of control of functions in a vehicle is facilitated by integration of operator controls and control actions for the occupant of the vehicle; integration of an operator control with a multi-function knob simplifies control actions and functions and integrates components/parts and assembly; operator controls may be provided with multiple control modes at a multi-function knob. See FIGS. 1C, 2A-2G, 3, 4, 5A-5B, 32, 32A-32B, 33, 33A-33B, 34, 34A-34B, 35, 35A-35B, 36, 36A-36B, 37, 37A-37B, 38, 38A-38B, 39, 39A-39B, 40, 40A-40B, 41, 41A-41B, 42A-42C, 43A-43B and 44A-44B.

As indicated schematically in the FIGURES, a vehicle interior component C may comprise an operator control shown as multi-function knob D providing multiple control actions as indicated schematically such as rotation (FIGS. 32, 32A-32B, 33, 33A-33B, 34 and 34A-34B) and movement up/down on a Z-axis (FIGS. 33, 33A-33B, 34 and 34A-34B) and vibration/haptics (FIG. 35A) and touch/sensing (FIG. 35) and illumination (FIG. 35B) and movement on an X-axis and Y-axis (as in FIGS. 36, 36A-36B, 37, 37A-37B, 38, 38A-38B, 39, 39A-39B, 40, 40A-40B, 41 and 41A-41B) and an image/light display providing an icon/information (FIGS. 42A-42C) and connection to vehicle systems through an interface (FIGS. 43A-43B). See also FIGS. 1C, 2A-2G, 3, 3A-3C, 4, 4A-4C and 44A-44B. As indicated schematically in FIGS. 43A-43B and 44A-44B, the operator control/multi-function controller may be configured to provide multiple control actions including rotation, up-down action (Z-axis) motion, left-right/front-back action (X-axis and Y-axis) motion, touch-sensor/haptic action at a user interface configured to provide an input device (e.g. sensor/detector, etc.) and output device (e.g. display/light, etc.); the operator control may comprise a multi-function controller with a knob/dial configured to provide control action and an user interface with a sensor/sensor set (e.g. touch sensor/detector, photo-electric detector, etc.) and a switch set (e.g. micro switch arrangement) and an magnet system (e.g. magnetic elements) and a light/display (e.g. illuminated dial) for image/icon/information presentation and a haptic/vibration/audio system and a gear/track system and a motor/actuator with a system interface configured to connect to the vehicle system/network.

According to an exemplary embodiment shown schematically in FIGS. 1C, 2A-2G, 3, 4, 5A-5B, 6, 7, 8, 9, 10A-10B, 11A-11B, 12A-12B, 13A-13B, 14, 15, 16, 17, 18, 19, 20, 21, 22, 23, 24, 25 and 26, an operator control comprising a multi-function knob/dial with mechanism is provided for a vehicle interior component to present a user interface for vehicle occupants and to provide a system interface with vehicle systems/network; the operator control/module/mechanism of the operator control may comprise a trim ring assembly, display screen assembly, rotating inner housing, fixed bearing base assembly, left and right sliding components for a magnet arrangement, left and right sliding components for a spring arrangement, a fixed base assembly providing left and right sliding rails, front and rear sliding assembly, front and rear slide rail fixing base assembly, a non-use/off state/position and a use/on state/position for the multi-function knob.

According to an exemplary embodiment an operator control may comprise a multi-functional knob/dial comprising a functional mechanism and a rotary lifting mechanism; the rotary lifting mechanism may comprise a housing 140 and a motor assembly 150 mounted on the housing 140; the housing 140 may be fixedly mounted on the vehicle and the functional mechanism may be driven by the motor assembly 150 to switch between a non-use/off state and a use/on state and provide a function in the use/on state.

The functional mechanism may comprise a pressing and pulling rotation mechanism, the pressing and pulling rotation mechanism may comprise a trim assembly 1, a display screen assembly 3 and a control board 6; the trim assembly 1 may comprise a metal trim ring 14 and a metal sheet 15; the display screen assembly 3 is capable of lifting and mounting and may have a thrust bearing assembly; the metal sheet 15 is in contact with the metal trim ring 14 to transfer a touch signal generated by the user touching the metal trim ring 14; the thrust bearing assembly and the wire harness are connected to the metal sheet 15 and the control board 6 to transmit the touch signal to the control board 6.

The thrust bearing assembly may comprise a bearing upper cover 32, a needle roller assembly 33 and a bearing lower cover 34; the bearing upper cover 32 may be rotatably supported on the bearing lower cover 34 by the needle roller assembly 33, the metal sheet 15 may be fixedly connected to the bearing upper cover 32 such that the bearing upper cover 32 rotates with the metal sheet 15, the bearing lower cover 34 may be mounted on the bearing support 37 and may be connected to the control panel 6 by a wire harness to transmit a touch signal. Pressing and pulling rotation mechanism may comprise a rotating inner housing 4 having a plurality of ribs 41, the control plate 6 may be provided with an infrared sensor 61 and when the trim ring assembly 1 rotates, the infrared sensor 61 generates or eliminates a signal to directly read the rotation angle of the trim assembly 1 by the signal. The rotating inner shell 4 may have a concave-convex structure 42, the push-pull rotary mechanism may comprise a fixed bearing base assembly 5 having a clutch mechanism 56, the clutch mechanism 56 may comprise a ball 562, a spiral spring 564 and a push block 565 and the push block 565 acts on the spiral spring 564 such that the ball 562 presses against the concave-convex structure 42 to generate a knob damping force and feed back the rotational gear feel. The spiral spring 564 and the push block 565 are replaced with a pair of opposite magnets to eliminate mechanical noise. The fixed bearing base assembly 5 may comprise two spring pistons 54, 55 and a connecting rod 53 rotatably assembled on the display screen assembly 3 by a connecting rod shaft 58, the control plate 6 having two micro switches 62, 63 spaced apart from each other; When the display screen assembly 3 is pressed, one side of the connecting rod 53 is lowered to press one spring piston 54 to trigger one microswitch 62; when the display screen assembly 3 is pulled, the other side of the connecting rod 53 is lowered to press the other spring piston 55 to trigger another microswitch 63. Pressing and pulling rotation mechanism may comprise a vibrator 75 assembled on the left and right sliding assemblies 7 to provide a vibration reminding function.

As indicated schematically, the functional mechanism may comprise a left-right sliding assembly 7, a left-right sliding rail fixing base assembly 8, a front-rear sliding assembly 9 and a front-rear sliding rail fixing base assembly 10; the left-right sliding rail fixing base assembly 8 may be fixedly connected to the front-rear sliding rail fixing base assembly 10, the front-rear sliding assembly 9 may have left and right rails 92 that cooperate with the left-right sliding assembly 7 to control the left-right direction to move horizontally and the front-rear sliding rail fixing base assembly 10 may have front and rear rails 102 that cooperate with the front-rear sliding assembly 9 to control the front-to-rear direction to toggle and translate. The front and rear sliding assemblies 9 and the front and rear sliding rail fixing base assemblies 10 comprise the same polarity magnets 93,103 that provide the forward and backward directions to toggle the damping force and the return force and the left and right sliding assemblies 7 and the left and right sliding rail fixing base assemblies 8 comprise the same polarity magnets 72, 82 that provide the left and right directions to toggle the damping force and the return force. The polarity magnet may be replaced with a coil spring 72′, 93′ to provide the damping force and the return force of the knob when the knob is toggled in the front-rear and left-right directions. Bolts 94 assembled on the front and rear sliding assemblies 9 trigger the micro switches 104 on the front side or the rear side front and rear sliding rail fixing base assemblies 10 as the front and rear directions of the knob to emit signals and the bolts 73 assembled on the left and right sliding assemblies 7 trigger the micro switches 83 on the left or right sliding rail fixing base assembly 8 on the left or right side to emit signals when the bolts 73 mounted on the left and right sliding assemblies 7 are toggled in the left and right directions.

The housing 140 may be a single piece and the functional mechanism may be driven by the motor assembly 150 to rotate and descend in the housing 140; housing 140 may be provided with a spiral groove 141, the rotary lifting mechanism may comprise an inner upper housing 2, the functional mechanism may be assembled on the inner upper housing 2, the inner upper housing 2 may be provided with a sliding block 21 and the sliding block 21 may be slidably fitted in the spiral groove 141. The rotary lifting mechanism may comprise an inner bottom shell 130 fixedly connected to the inner upper shell 2, the inner bottom shell 130 may be provided with a first shell gear 131, the motor assembly 150 may be provided with a motor gear 151 and a transmission gear 152, the motor gear 151 and the transmission gear 152 and the first shell gear 131 are each engaged with each other to enable the functional mechanism to realize rotary lifting. The housing 140 may comprise a fixed housing 140a and a rotating housing 140b, the fixed housing 140a may be fixedly mounted on the vehicle, the rotating housing 140b may be provided in the fixed housing 140a and may be rotatable relative to the fixed housing 140a and cannot be lifted and the functional mechanism may be driven by the motor assembly 150 to be liftable and non-rotatable relative to the fixed housing 140a. The multifunctional knob of claim 16 the rotating shell 140b may have a spiral groove 141, the rotary lifting mechanism may comprise an inner upper shell 2, the functional mechanism may be assembled on the inner upper shell 2, the inner upper shell 2 may be provided with a sliding block 21 and the sliding block 21 may be slidably fitted in the spiral groove 141. The rotating shell 140b may have a second shell gear 142; the motor assembly 150 may have a motor gear 151 and a transmission gear 152; the motor gear 151 and the transmission gear 152 and the second shell gear 142 are each engaged with each other to drive the rotating shell 140b to rotate. The rotary lifting mechanism may comprise an inner bottom shell 130 fixedly connected to the inner upper shell 2, the inner bottom shell 130 may be provided with a plurality of eccentric protruding pins 132 and the plurality of eccentric protruding pins 132 cooperate with the fixed shell 140a such that the inner bottom shell 130 may be liftable and non-rotatable relative to the fixed shell 140a. The multi-function knob may have a housing 140, a functional mechanism and a driving mechanism; the housing 140 may be fixedly mounted on the vehicle; the driving mechanism may be mounted on the housing 140, the functional mechanism may be adapted to be driven by the driving mechanism to ascend or descend between a non-use/off state and a use/on state relative to the housing 140 and provides a function in the use/on state by at least one of the following operations: pressing, pulling, pulling in at least one direction and rotating.

As indicated schematically, an operator control for a component may comprise a multifunctional knob comprising a functional mechanism and a rotary lifting mechanism. The rotary lifting mechanism may comprise a fixed housing and a motor assembly mounted on the fixed housing; the fixed housing may be fixedly mounted on a vehicle; and the functional mechanism may be driven by the motor assembly to implement switching between an non-use/off state and a use/on state (e.g. to provide control functions/actions in the use/on state); multiple functions of the knob may be integrated; the knob may be coordinated with the automotive interior style in the non-use/off state (e.g. silent/quiet, retracted, etc.) and an enhanced/luxury feel may be provided when the knob is switched to the use/on state.

As indicated schematically, to achieve simplification and to satisfy integration objectives for a vehicle interior component with vehicle systems, a multi-function knob may have a functional mechanism and a rotating lifting mechanism; the rotating lifting mechanism may comprise a housing and a motor assembly mounted on the housing; the housing may be fixedly mounted on the vehicle and the functional mechanism is driven by the motor assembly to switch between a non-use/off state and a use/on state and provide a function in the use/on state. Multiple modes of control action may be provided at a user interface; coordination with the vehicle interior decoration style in the silent mode and the presentation of enhanced appearance features and luxury and performance may be provided in a use/on mode.

As indicated schematically, the functional mechanism may comprise a pressing and pulling rotation mechanism, the pressing and pulling rotation mechanism may comprise a trim assembly, a display screen assembly and a control board, the trim assembly may comprise a metal trim ring and a metal sheet, the display screen assembly may be liftable and mounted and may have a thrust bearing assembly, the metal sheet is in contact with the metal trim ring to transfer a touch signal generated by the user to touch the metal trim ring and the thrust bearing assembly and the wire harness are connected to the metal sheet and the control board to transmit the touch signal to the control board.

As indicated schematically, the thrust bearing assembly may comprise a bearing upper cover, a needle roller assembly and a bearing lower cover; the bearing upper cover may be rotatably supported on the bearing lower cover by the needle roller assembly, the metal sheet may be fixedly connected to the bearing upper cover such that the bearing upper cover rotates with the metal sheet, the bearing lower cover may be mounted on the bearing support and may be connected to the control board by the wire harness to transmit the touch signal.

As indicated schematically, the pressing and pulling rotation mechanism may comprise a rotating inner housing having a plurality of ribs, the control plate may have an infrared sensor and when the trim assembly rotates, the infrared sensor generates or eliminates a signal to directly read the rotation angle of the trim ring assembly through the signal.

As indicated schematically, the rotating inner shell may have a concave-convex structure, the push-pull rotary mechanism may comprise a fixed bearing base assembly having a clutch mechanism, the clutch mechanism may comprise a ball, a coil spring and a push block; the push block acts on the coil spring to compress the ball against the concave-convex structure to generate the knob damping force and feed back the rotational gear feel.

As indicated schematically, the coil spring and the push block may be replaced with a pair of opposite poles to eliminate mechanical noise.

As indicated schematically, the fixed bearing base assembly may comprise a two-spring piston and a connecting rod rotatably assembled on the display screen assembly through the connecting rod shaft and the control plate may have two micro-switches spaced apart from each other; when the display screen assembly is pressed, one side of the connecting rod is lowered to press one spring piston to trigger one micro-switch; and when the display screen assembly is pulled, the other side of the connecting rod is lowered to press the other spring piston to trigger the other micro-switch.

As indicated schematically, the functional mechanism may comprise a left-right sliding assembly, a left-right sliding rail fixing base assembly, a front-rear sliding assembly and a front-rear sliding rail fixing base assembly; the left-right sliding rail fixing base assembly may be fixedly connected to the front-rear sliding rail fixing base assembly, the front-rear sliding assembly has left and right rails that cooperate with the left-right sliding assembly to control the left-right direction to move horizontally and the front-rear sliding rail fixing base assembly may have front and rear rails that cooperate with the front-rear sliding assembly to control the front-to-rear direction to toggle and translate.

As indicated schematically, the front and rear sliding assemblies and the front and rear sliding rail fixing base assemblies include a same polarity magnet that provides a forward and backward direction to toggle the damping force and the return force and the left and right sliding assemblies and the left and right sliding rail fixing base assemblies include a same polarity magnet that provides a left-right direction to toggle the damping force and the return force.

As indicated schematically, the same polarity magnet is replaced with a coil spring to provide both the damping force and the return force when the knob is toggled in front-to-back direction and left-to-right directions.

As indicated schematically, the bolts mounted on the front and rear sliding assemblies trigger the micro switches on the front side or the rear side to fix the micro switches on the base assembly as the front and rear directions of the knob to emit signals and the bolts assembled on the left and right sliding assemblies trigger the micro switches on the left or right sliding rail fixing base assembly on the left side or the right side to emit signals when the bolts on the left and right sliding assemblies are toggled in the left and right directions.

As indicated schematically, the pressing and pulling rotation mechanism may comprise a vibrator assembled on the left and right sliding components to provide a vibration function (e.g. for notification, reminder, etc.).

As indicated schematically, the housing may be a single piece and the functional mechanism may be driven by the motor assembly to rotate and descend in the housing.

As indicated schematically, the housing may have a spiral groove, the rotary lifting mechanism may comprise an inner upper shell, the functional mechanism may be assembled on the inner upper shell, the inner upper shell may have a sliding block and the sliding block may be slidably fitted in the spiral groove.

As indicated schematically, the rotary lifting mechanism may comprise an inner bottom shell fixedly connected to the inner upper shell, the inner bottom shell may have a first shell gear, the motor assembly may have a motor gear and a transmission gear and the motor gear; the transmission gear may be engaged with the first shell gear to enable the functional mechanism to realize rotary lifting.

As indicated schematically, the housing may comprise a fixed housing and a rotating housing; the fixed housing may be fixedly mounted on the vehicle, the rotating housing may be disposed in the fixed housing and rotatable relative to the fixed housing; the functional mechanism may be driven by the motor assembly to be liftable and non-rotatable relative to the fixed housing.

As indicated schematically, the rotary housing may have a spiral groove, the rotary lifting mechanism may comprise an inner upper shell; the functional mechanism may be assembled on the inner upper shell; the inner upper shell may have a sliding block; the sliding block may be slidably fitted in the spiral groove.

As indicated schematically, the rotating housing may have a second housing gear, the motor assembly may have a motor gear and a transmission gear; the motor gear and the transmission gear may be engaged with the second housing gear to drive the rotating housing to rotate.

As indicated schematically, the rotary lifting mechanism may comprise an inner bottom shell fixedly connected to the inner upper shell; the inner bottom shell may be provided with a plurality of eccentric protruding pins and the plurality of eccentric protruding pins cooperate with the fixed shell so that the inner bottom shell may be liftable and non-rotatable relative to the fixed shell.

A multi-function knob may comprise a housing, a functional mechanism and a driving mechanism such as a motor assembly; the housing may be fixedly mounted on the vehicle; the driving mechanism may be mounted on the housing; the functional mechanism may be adapted to be driven by the driving mechanism to move up and down relative to the housing between a non-use/off state and a use/on state and to provide a function in the use/on state by at least one of the following operations: pressing, pulling, pulling in at least one direction and rotating.

According to the multi-function knob of the present disclosure, the push-pull rotation mechanism and the left and right toggle mechanisms may be driven by the motor assembly for switching between the non-use/off state and the use/on state; the mechanism may be concealed/hidden with the mechanism in the non-use/off state avoiding false touch and mis-operation (e.g., rotating the rising/straight line during use and improving the cabin ceremonies. As indicated schematically, according to the multi-function knob of the present disclosure, various dimensions of manipulation and display functions are integrated, including a rotation knob function, a pressing manipulation function, a pulling operation control function, a front-and-rear translation toggle control function and a left-right translation toggle control function and may also integrate interaction functions such as left-right tilt toggle control function, left-right tilt toggle control function, screen display function, touch sensing function and vibration reminder.

TABLE A
REFERENCE SYMBOL LIST

| REFERENCE | |
|---|---|
| SYMBOL | ELEMENT, PART OR COMPONENT |
| V | VEHICLE |
| VI | VEHICLE INTERIOR |
| C | COMPONENT |
| FC | Console/console assembly (e.g. floor console) |
| IP | instrument panel |
| DP | Door panel |
| SW | Steering wheel |
| SZ | Seat/seat assembly |
| OHC | Overhead system/console |
| D | Control member for operator control/system |
| | (e.g. multi-function knob/dial) |
| Dx | Section of operator control system/module |
| T | Cover/surface |
| | (e.g. decorative surface, decorative plate, etc.) |
| M | Module/system |
| | (e.g. actuator, motor, etc.) |
| B | Base (e.g. structure, housing, etc.) |
| UI | User interface |
| ID | Input device |
| OD | Output device |
| SN | Sensor/detector |
| HP | Haptic/audio system/module |
| | (e.g. transducer, actuator, etc.) |
| LD | Light/display |
| IC | Image display (e.g. indicator, icon, |
| | information display, illuminated form, etc.) |
| MDX | Area/region of operator control/system/module |
| | to provide for movement along X-axis |
| MDY | Area/region of operator control/system/module |
| | to provide for movement along Y-axis |
| MDZ | Area/region of operator control/system/module |
| | to provide for movement along Z-axis |
| 1 | Decorative Ring Assembly |
| 2 | Inner Upper Shell |
| 3 | Display Screen Assembly |
| 4 | Rotating Inner Shell |
| 5 | Fixed Bearing Base Assembly |
| 6 | Control Panel |
| 7 | Left and Right Sliding Component |
| 8 | Left and Right Slide Rail Fixed Base Assembly |
| 9 | Front and Back Sliding Component |
| 9′, 17, 18, 19 | Front and Rear Sliding Assembly |
| 10, 10′ | Front and Back Slide Rail Fixed Base Assembly |
| 11 | Transparent Cover (Also used for “Front and Rear |
| | Sliding Assembly”) |
| 12 | Glue (Also used for “Front and Rear Sliding Assembly”) |
| 13 | Bezel Bracket (Also used for “Front and Rear Sliding |
| | Assembly”) |
| 14 | Metal Bezel |
| 15 | Metal Sheet |
| 16 | Rotating Bracket |
| 21, 921, 1021 | Slider |
| 31 | Display Screen |
| 32 | Upper Bearing Cover |
| 33 | Needle Roller Assembly (Also used for “Ball Assembly”) |
| 34 | Lower Bearing Cover |
| 35 | Axle Pin Bolt (Also used for “Spring Mechanism”) |
| 35, 38 | Spring Mechanism |
| 36 | Display Screen Bracket |
| 37, 52 | Bearing Bracket |
| 38 | Compression Springs (Also used for “Spring |
| | Mechanism”) |
| 41 | Ribs |
| 42 | Concave-Convex Mechanisms |
| 51, 120 | Ball Bearing |
| 53 | Connecting Rod, Lever |
| 54, 55 | Spring Piston |
| 56 | Clutch Mechanism |
| 57 | Fixed Bearing Base |
| 58 | Connecting Rod Shaft |
| 59 | Knob Outer Positioning Ring |
| 61 | Infrared Sensor |
| 62, 63, 83, 104 | Micro Switch |
| 71 | Brackets |
| 72, 82, 93, 103 | Magnet |
| 72′, 93′, 564 | Coil Spring |
| 73, 76, 94, 97 | Bolt |
| 74 | Left and Right Centered Locking Magnets |
| 75 | Vibrators |
| 81 | Left and Right Rail Fixing Brackets |
| 84 | Rear Center Locking Magnets/Front-to-Back Center |
| | Locking Magnet |
| 91 | Front-to-Back Sliding Bracket |
| 91′ | Front and Rear Sliding Brackets |
| 92 | Left-to-Right Rail |
| 95 | Front-to-Back Center Locking Magnet |
| 96 | Left-to-Right Center Locking Magnet |
| 101, 101′ | Front and Rear Rail Fixing Bracket |
| 102 | Front and Rear Rail |
| 110 | Central Shaft |
| 130 | Inner Bottom Shell |
| 131 | Shell Gear |
| 132 | Bottom Eccentric Pin |
| 140 | Outer Shell/Housing |
| 140a | Fixed Housing |
| 140b | Rotating Housing |
| 141 | Spiral Groove |
| 142 | Housing Gear |
| 143 | Bottom Protrusion |
| 150 | Motor Assembly |
| 151 | Motor Gear |
| 152 | Transmission Gear |
| 561 | Cover |
| 562 | Ball |
| 563 | Housing/Inner Cavity of the Shell |
| 565 | Push Block |
| 566 | Stop Bolt |

It is important to note that the present inventions e.g. inventive concepts, etc. have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter e.g. modifications, variations, embodiments, combinations, equivalents, etc. is intended to be included within the scope of the present inventions. It should also be noted that various/other modifications, variations, substitutions, equivalents, changes, omissions, etc. may be made in the configuration and/or arrangement of the exemplary embodiments e.g. in concept, design, structure, apparatus, form, assembly, construction, means, function, system, process/method, steps, sequence of process/method steps, operation, operating conditions, performance, materials, composition, combination, etc. without departing from the scope of the present inventions; all such subject matter e.g. modifications, variations, embodiments, combinations, equivalents, etc. is intended to be included within the scope of the present inventions. The scope of the present inventions is not intended to be limited to the subject matter e.g. details, structure, functions, materials, acts, steps, sequence, system, result, etc. described in the specification and/or illustrated in the FIGURES of the present patent document. It is contemplated that the claims of the present patent document will be construed properly to cover the complete scope of the subject matter of the present inventions e.g. including any and all such modifications, variations, embodiments, combinations, equivalents, etc.; it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology e.g. as implemented and/or integrated in exemplary embodiments, modifications, variations, combinations, equivalents, etc., or may comprise any other applicable technology present and/or future with suitability and/or capability to perform the functions and processes/operations described in the specification and/or illustrated in the FIGURES. All such technology e.g. as implemented in embodiments, modifications, variations, combinations, equivalents, etc. is considered to be within the scope of the present inventions of the present patent document.

The invention claimed is:

1. A component for a vehicle interior configured to provide a user interface comprising:
an operator control comprising a base comprising a module and a control member connected to the module;
wherein the operator control is configured to provide the user interface at the cover;
wherein the user interface comprises an input device and/or an output device;
wherein the control member of the operator control comprises the input device for the user interface.

2. The component of claim 1 wherein the input device comprises at least one of a movement detector and/or a touch sensor

3. The component of claim 1 wherein the control member of the operator control comprises the output device for the user interface.

4. The component of claim 1 wherein the output device comprises at least one of a visual display and/or a light display and/or an information display and/or a haptics output.

5. The component of claim 1 wherein the control member comprises a multi-function control member configured to provide multiple control actions for the module of the operator control for at least one system of the vehicle.

6. The component of claim 1 wherein the module comprises an actuator for the operator control and/or for the output device provided at the operator control.

7. The component of claim 1 wherein the output device is configured to provide actuation and/or haptic output and/or vibration.

8. The component of claim 1 wherein the base comprises a housing for the module.

9. The component of claim 1 further comprising a cover for the base; wherein the module is under the cover.

10. The component of claim 1 wherein the control member comprises a knob.

11. The component of claim 1 wherein the control member comprises a light display.

12. The component of claim 1 wherein the control member comprises a sensor and/or a detector and/or a touch sensor and/or a member configured to operate as a switch.

13. The component of claim 1 wherein the operator control comprises a default state where the control member is recessed into the cover.

14. The component of claim 1 wherein the control member is configured for movement relative to the base.

15. The component of claim 1 wherein the control member is configured for movement relative to the base for control actions for a system of the vehicle.

16. The component of claim 1 wherein the operator control is configured to provide control action at the control member for operation of at least one system of the vehicle.

17. The component of claim 1 wherein the control member is configured for rotation movement relative to the base; wherein the control member is configured for lateral movement relative to the base; wherein the control member is configured for up-and-down movement relative to the base.

18. The component of claim 1 wherein movement of the control member relative to the base comprises all of lateral movement and up-and-down movement and rotation movement.

19. The component of claim 1 wherein movement of the control member of the operator control is detected at the module of the operator control.

20. The component of claim 1 wherein the module of the operator control is configured to facilitate actuation for the control member.
